(19) United States
(12) Patent Application Publication
(10) Pub. No.: US 2012/0174602 A1
(43) Pub. Date: Jul. 12, 2012

(54) SYSTEM FOR THE OVERALL CONTROL OF HEAT FOR ELECTRICALLY PROPELLED MOTOR VEHICLE

(75) Inventors: Gerard Olivier, Bougival (FR); Jean-Philippe Claeys, Sevres (FR); Robert Yu, Montigny le Bretonneux (FR)

(73) Assignee: RENAULT S.A.S., Boulogne-Billancourt (FR)

(21) Appl. No.: 13/389,345

(22) PCT Filed: Jun. 15, 2010
(86) PCT No.: PCT/FR2010/051184

§ 371 Date: Mar. 19, 2012

(30) Foreign Application Priority Data
Aug. 7, 2009 (FR) 0955566

(51) Int. Cl. F25B 29/00; B60H 1/32; B60H 1/22

(52) U.S. Cl. 62/79; 165/43; 62/238.1

(57) ABSTRACT

A system for overall control of heat for a passenger compartment and for electrical units in a motor vehicle that is completely or partially propelled by an electric engine powered by a battery, including a heat-control fluid circuit coupled to a heating device and/or to a cooling device enabling the fluid to store calories or frigories when the system is plugged into an electrical network outside of the vehicle. The fluid circuit is capable of releasing calories and/or frigories to the air of the passenger compartment, in an alternating manner, either through a heat exchanger between the circuit and the air of the passenger compartment, or using a climate circuit forming a heat pump and/or an air-conditioning system.

The present invention relates to a heat regulation device for the passenger compartment of a motor vehicle, in particular of electric or hybrid type.

As for motor vehicles with internal combustion engines, electric or hybrid motor vehicles have to incorporate a system for conditioning the temperature of the air in the passenger compartment. These conditioning systems ensure the comfort of the passengers and provide additional functions such as demisting and deicing glazed surfaces. Electrically-propelled vehicles also have to incorporate temperature regulation systems, which regulate the temperature of the accessories such as chargers, computers and electronic components, and the temperature of the electric engine (which has to remain at approximately 20° C. when it is in demand, and must not exceed 50° C.) and the temperature of the battery (which would otherwise risk rising to high temperatures during rapid recharging cycles, while its operating range is, for example, between −10° C. and 35° C.)

The operation of the conditioning systems of internal combustion vehicles uses a significant quantity of energy which is “fatally dissipated” in the form of heat, and which is not available in electric vehicles, or even hybrid vehicles, given that, in the latter, the heat engine may be stopped for significant periods.

Current solutions, implemented in vehicles with internal combustion engines, would require the use of resistive elements with positive temperature coefficient (or PTC, which are self-regulated resistors avoiding the risks of overheating) or the use of a fuel burner to produce heat energy, and a conventional air conditioning system to produce cool air in the passenger compartment. However, a fuel burner has the drawbacks of being polluting and noisy, and of needing to be filled with fuel, whereas PTC elements or conventional air conditioning systems are consumers of electricity. Furthermore, the heating/cooling systems are separate and work for only a part of the year, which implies a significant cost and a modification of the behavior of the driver, whether in winter (with the possible filling with heating fuel) or in summer (with the reduced range of the vehicle due to the electrical consumption of the air conditioning system).

There are currently devices for regulating the temperature of the passenger compartment that can provide heating and air conditioning functions, such as those described, for example, in the documents EP 1 302 731 or even FR 2 850 060. However, these systems are still energy consumers, and therefore reduce the range of the vehicle.

The patent application FR 2 709 097 proposes a regulation device including an accumulator of energy in the form of specific heat, which can operate either as a heat accumulator, or as a refrigeration accumulator. This accumulator is preheated or precooled by using the energy of an electricity network outside the vehicle while charging the battery, for example by using the heat released by the battery for the preheating. However, the configuration of the system allows the accumulator to be used only to condition the temperature of the air of the passenger compartment, and insofar as the temperature of the accumulator exhibits a temperature difference with the passenger compartment that is sufficient to ensure the required heat exchanges.

The aim of the invention is to remedy these drawbacks by improving the heat regulation of the passenger compartment of a motor vehicle, in particular in terms of energy consumption, in order to preserve the range of the vehicle. Another aim of the invention is to ensure the temperature control of the electric units so as to increase their efficiency and their life.

The subject of the invention is a heat regulation system for the passenger compartment and electric units of a motor vehicle propelled totally or partially by an electric engine powered by a battery, the system comprising a heat regulation fluid circuit coupled to a heating means and/or to a cooling means, making it capable of storing heat or refrigeration when the system is connected to an electricity network outside the vehicle. The fluid circuit is able to release heat and/or refrigeration to the air of the passenger compartment, in an alternating manner, either through a heat exchanger between the circuit and the air of the passenger compartment, or via a climate control circuit forming a heat pump and/or an air conditioning system.

Preferentially, the system comprises:
a first independent heat regulation fluid circuit for the passenger compartment, fed by a first pump and passing through a first heat exchanger for conditioning the temperature of a flow of air entering into the passenger compartment, or for conditioning the temperature of the battery,
a second independent heat regulation fluid circuit for the engine, fed by a second pump, passing through a heat exchange radiator exchanging heat with the air outside the vehicle, and passing through a second heat exchanger conditioning the temperature of the engine,
a third heat storage fluid circuit, which can be alternatively connected to the first circuit and/or be connected to the engine temperature conditioning heat exchanger, and which can at other times form a separate independent fluid circulation loop,
a climate control circuit forming a heat pump and/or air conditioning system, capable of taking, via a first condenser-evaporator, heat or refrigeration from the third fluid circuit, and of releasing this heat/refrigeration, via a second condenser-evaporator, to the first fluid circuit,
at least one electric heating element linked either to the first fluid circuit, or to the third fluid circuit, and used to raise, by several tens of degrees Celsius, the temperature of the third circuit, or the temperature of the two circuits connected together.

Advantageously, the system comprises at least three three-way valves or three equivalent devices, used in particular to stop the exchanges of fluid between the first circuit and the third circuit, and at the same time used to alternatively obtain the following configurations, consisting in:
either establishing a circulation of fluid between the engine temperature conditioning heat exchanger, the first condenser-evaporator, and the third fluid circuit,
or establishing a circulation of fluid between the heat exchange radiator exchanging heat with the air outside the vehicle and the first condenser-evaporator, the circulation of fluid of these two elements then being isolated from the third fluid circuit,
or establishing a circulation of fluid between the heat exchange radiator exchanging heat with the air outside the vehicle, the engine temperature conditioning heat exchanger and the first condenser-evaporator, the circulation of fluid of these three elements then being isolated from the third fluid circuit.

According to a preferred embodiment, the valves are also used to interrupt or reestablish the circulation of fluid between the second and the third circuits.

The third circuit may comprise a valve and a bypass line used to exclude the first condenser-evaporator from this circuit, or may comprise a plurality of valves and a plurality of bypass lines used to exclude, selectively, one or more condensers-evaporators from this circuit.

Advantageously, the system may comprise an outside air temperature sensor, a heat sensor arranged on the first fluid circuit or in the passenger compartment of the vehicle, a heat sensor arranged on the second fluid circuit or on the engine, and a heat sensor arranged on the third fluid circuit.

Preferentially, the volume of the fluid contained in the third circuit is greater than the volume of fluid contained in the first circuit and the volume of fluid contained in the second circuit.

The third fluid circuit may comprise a heat exchanger with a heat accumulation means such as a phase transformation heat accumulator.

According to another aspect, the subject of the invention is a heat regulation method for the passenger compartment and the electric units of a motor vehicle propelled totally or partially by an electric engine powered by a battery. The method is implemented by means of a device comprising a circuit of lines for heat regulation fluid, coupled to a heating means and/or to a cooling means. The method comprises the steps consisting in:
storing heat or refrigeration in the fluid circuit when the vehicle is connected to an electricity network outside the vehicle, particularly in order to recharge its battery,
then supplying heat (respectively, refrigeration) to the air of the passenger compartment from the fluid circuit initially through a heat exchanger between the circuit and the air of the passenger compartment, then via a climate control circuit forming a heat pump and/or air conditioning system.

Preferentially, to implement the method, the vehicle is equipped with:
a first independent heat regulation fluid circuit for the passenger compartment, fed by a first pump and passing through a first heat exchanger for conditioning the temperature of a flow of air entering into the passenger compartment, or for conditioning the temperature of the battery,
a second independent heat regulation fluid circuit for the engine, fed by a second pump, passing through a heat exchange radiator exchanging heat with the air outside the vehicle, and passing through a second engine temperature conditioning heat exchanger,
a third heat storage fluid circuit, which can be alternatively connected to the first circuit and/or be connected to the engine temperature conditioning heat exchanger, and which can at other times form a separate independent fluid circulation loop,
a climate control circuit forming a heat pump and/or air conditioning system, capable of taking, via a first condenser-evaporator, heat/refrigeration from the third fluid circuit, and of releasing this heat/refrigeration via a second condenser-evaporator to the first fluid circuit,

and the method comprises the following steps:
before the vehicle is started, the energy of an electricity network outside the vehicle is used to accumulate, using the heating element or using the climate control circuit, heat (respectively, refrigeration) in the third heat storage fluid circuit, possibly linked to the first circuit, by raising (respectively, by lowering) the temperature of this circuit relative to the temperature of the air outside the vehicle,
after the vehicle is started, the climate control circuit is deactivated, the third circuit is linked to the first circuit and/or to the engine temperature conditioning heat exchanger, and the heat (respectively, the refrigeration) stored in the third fluid circuit are used to condition the temperature of the passenger compartment plus, possibly, the engine and/or the battery,
when the temperature of the fluid of the third circuit crosses a minimum deviation representing the difference with the temperature of the air of the passenger compartment, the fluid circulation between the first circuit and the third circuit is decoupled, and the heat pump or the air conditioning system is made to operate, first of all between the first circuit or the passenger compartment and the third circuit, then between the first circuit or the passenger compartment and at least a part of the second circuit, the fluid circulation of the lines specific to the third circuit then being deactivated.

According to a preferred implementation, the temperature of the outside air, a temperature on the heat exchanger of the engine, a temperature in the passenger compartment of the vehicle, and a temperature of the third fluid circuit are compared with one another, to decide on how the first, second and third fluid circuits should be connected, and to decide on the mode of operation or the absence of operation of the climate control circuit.

Other aims, advantages and features of the invention will become apparent from studying the detailed description of a few embodiments given as nonlimiting examples and illustrated by the appended figures in which:

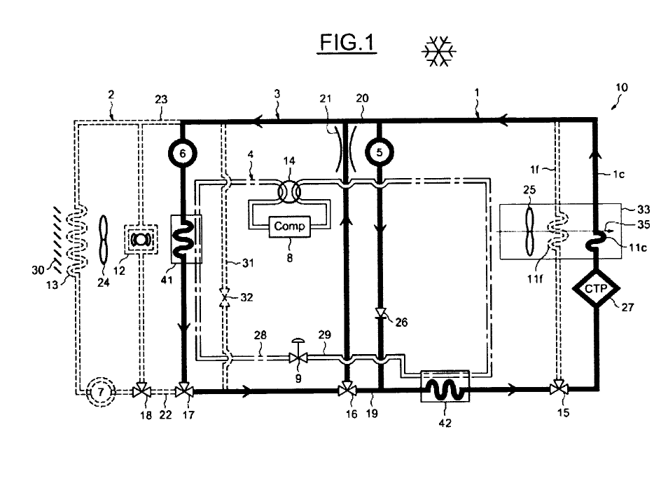

FIG. 1 illustrates a heat regulation system according to the invention, in a first winter operating mode;

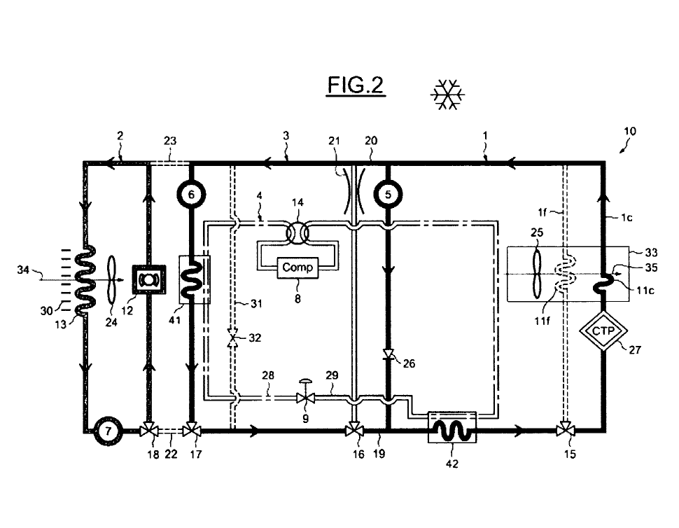

FIG. 2 illustrates the heat regulation system of FIG. 1, in a second winter operating mode;

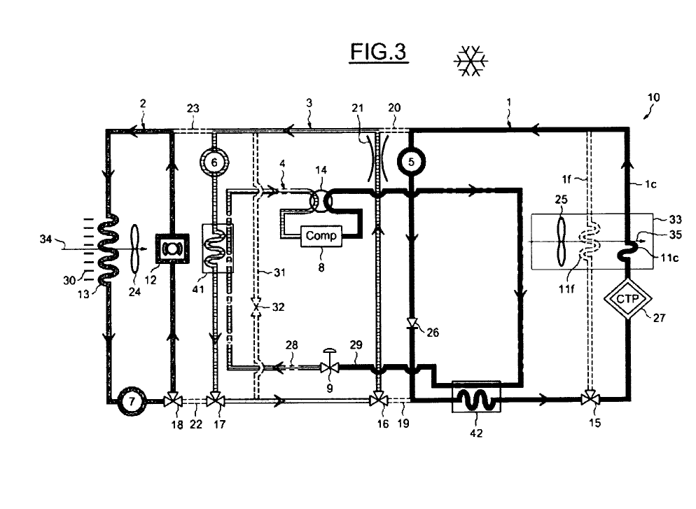

FIG. 3 illustrates the heat regulation system of FIG. 1, in a third winter operating mode;

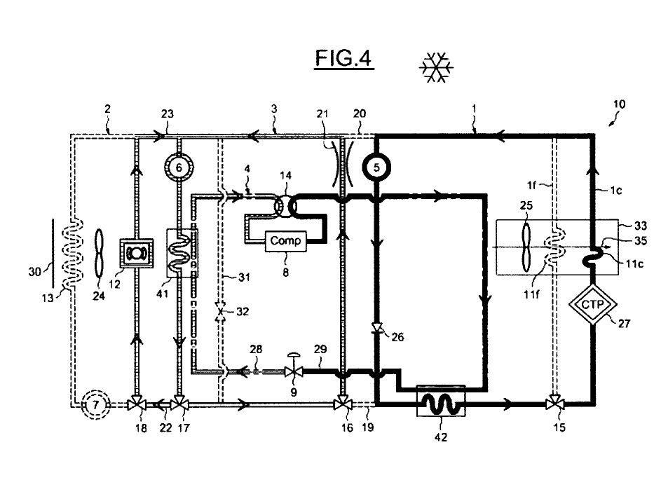

FIG. 4 illustrates the heat regulation system of FIG. 1, in a fourth winter operating mode;

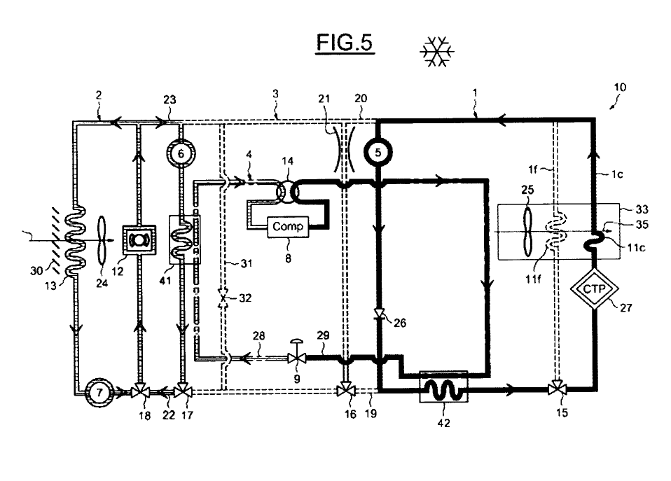

FIG. 5 illustrates the heat regulation system of FIG. 1, in a fifth winter operating mode;

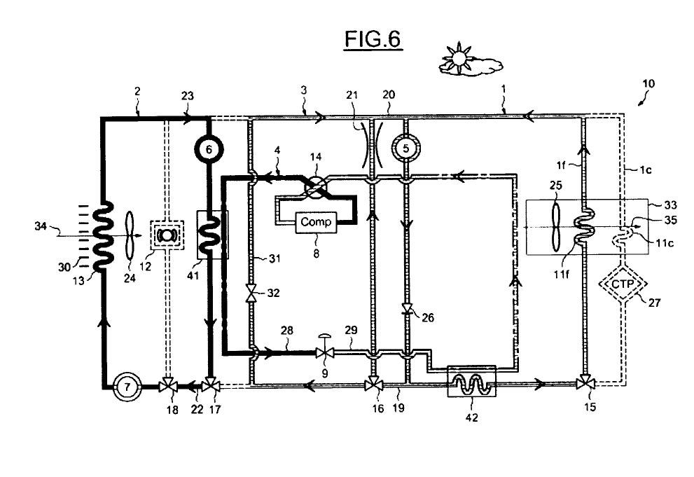

FIG. 6 illustrates the heat regulation system of FIG. 1, in a first summer operating mode;

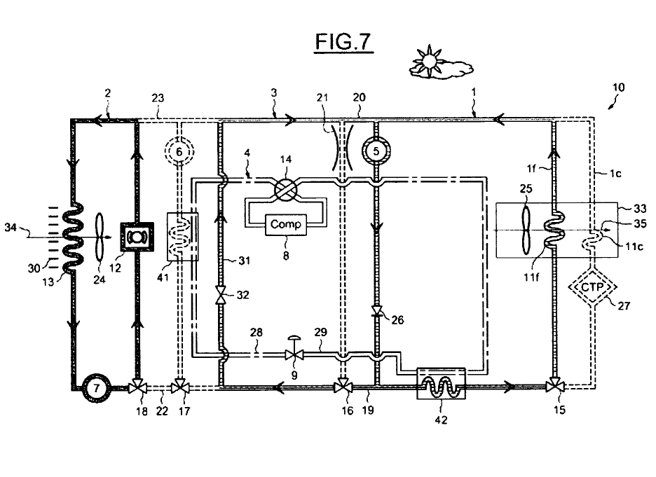

FIG. 7 illustrates the heat regulation system of FIG. 1, in a second summer operating mode;

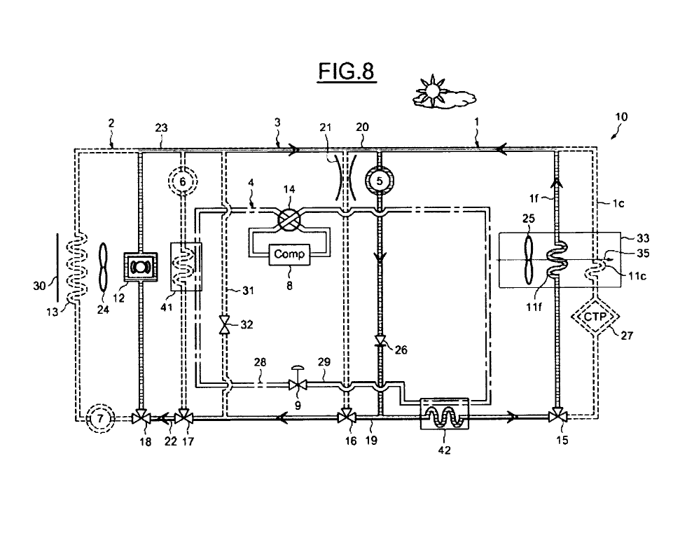

FIG. 8 illustrates the heat regulation system of FIG. 1, in a third summer operating mode;

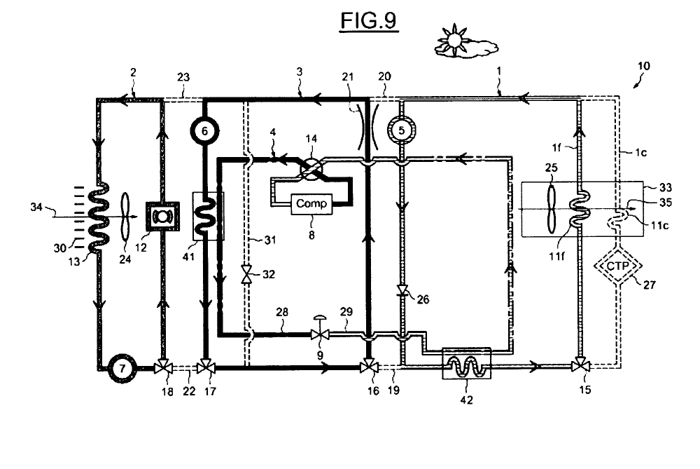

FIG. 9 illustrates the heat regulation system of FIG. 1, in a fourth summer operating mode;

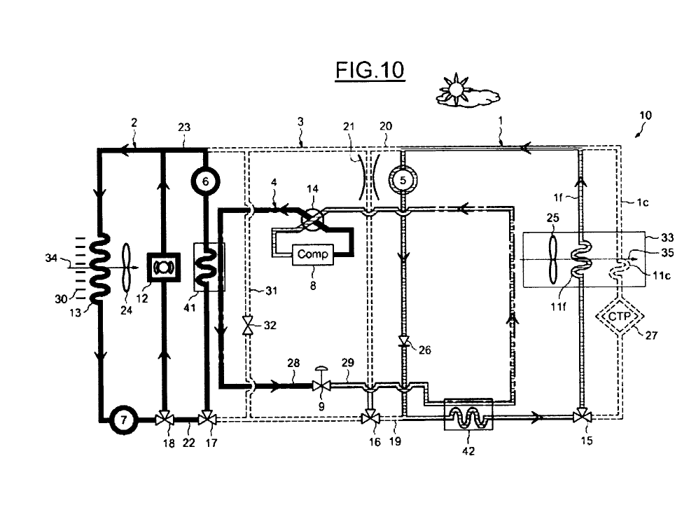

FIG. 10 illustrates the heat regulation system of FIG. 1, in a fifth summer operating mode;

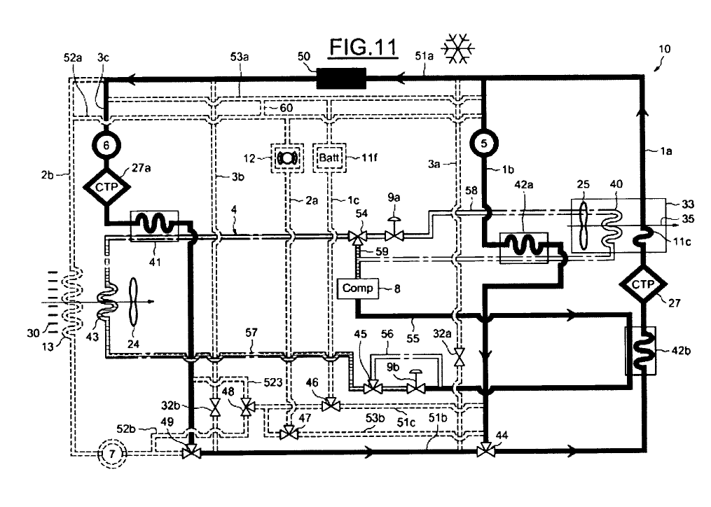

FIG. 11 illustrates another heat regulation system according to the invention, in a first winter operating mode;

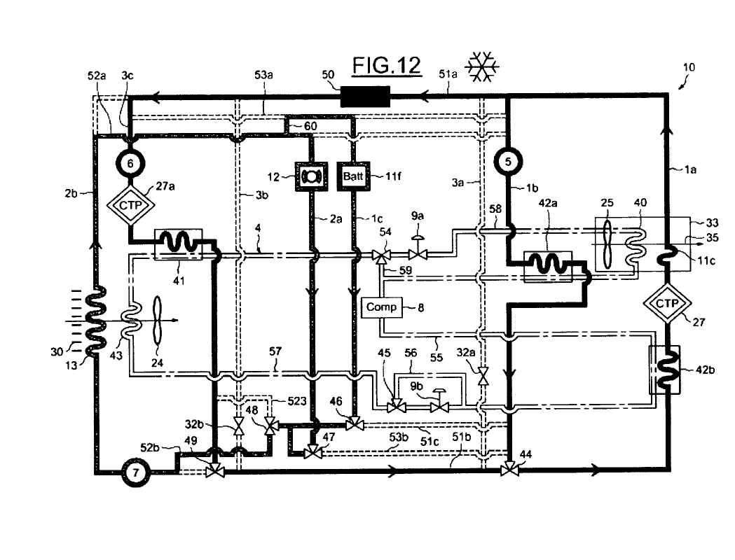

FIG. 12 illustrates the heat regulation system of FIG. 11, in a second winter operating mode;

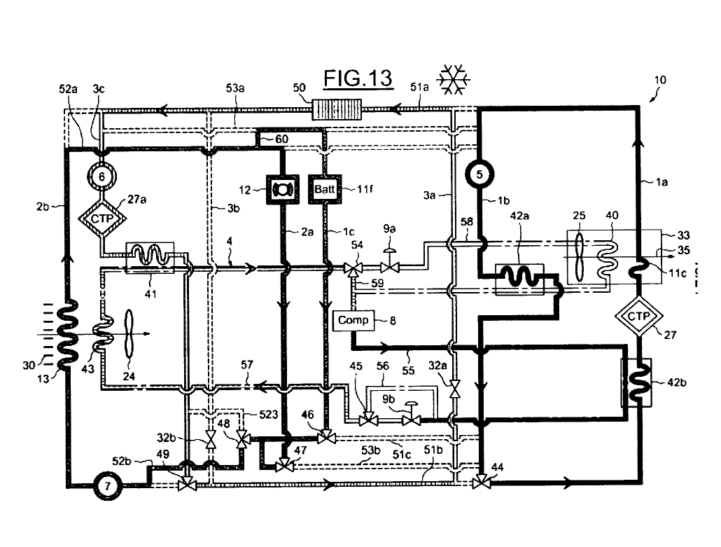

FIG. 13 illustrates the heat regulation system of FIG. 11, in a third winter operating mode;

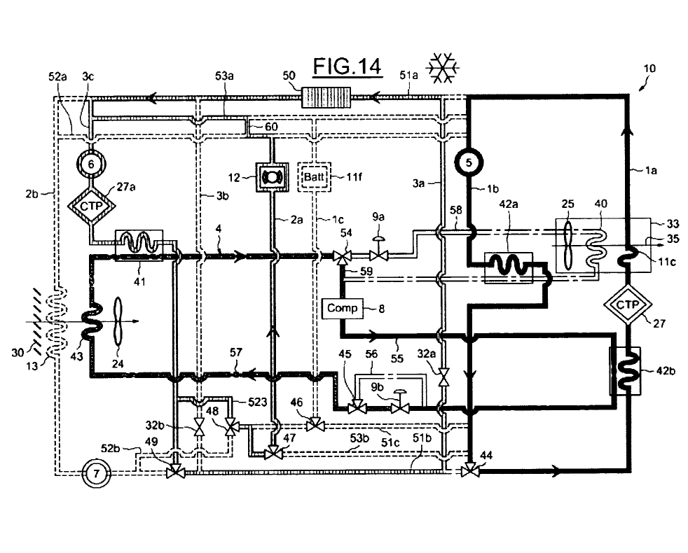

FIG. 14 illustrates the heat regulation system of FIG. 11, in a fourth winter operating mode;

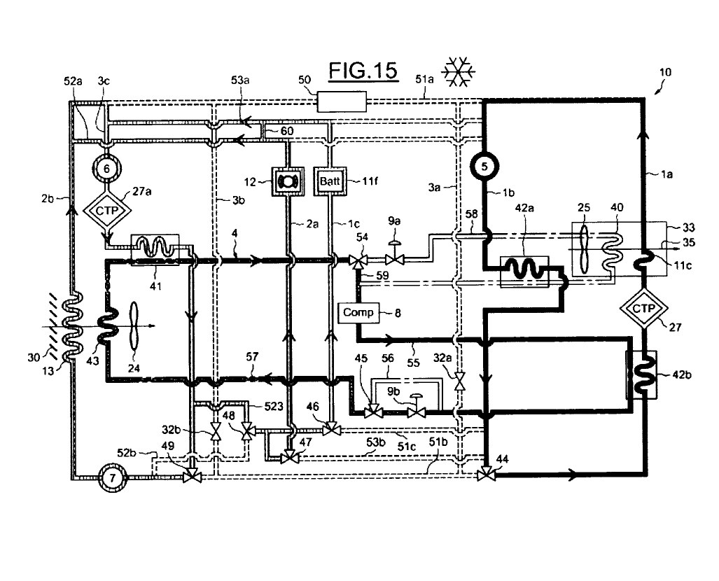

FIG. 15 illustrates the heat regulation system of FIG. 11, in a fifth winter operating mode;

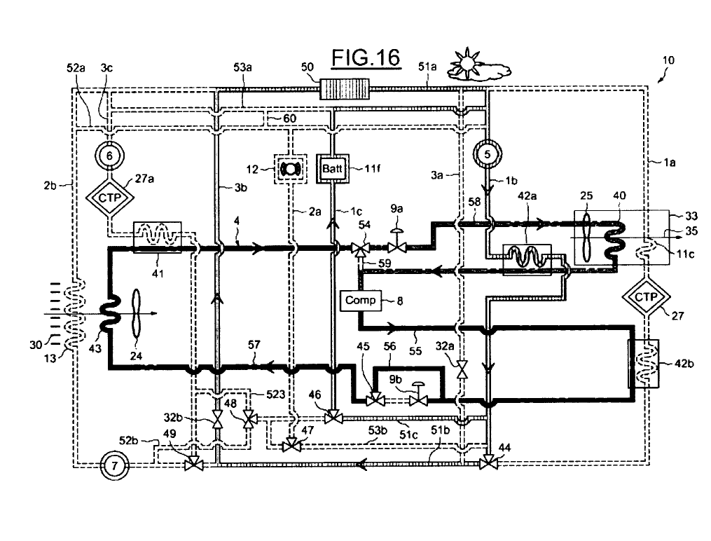

FIG. 16 illustrates the heat regulation system of FIG. 11, in a first summer operating mode;

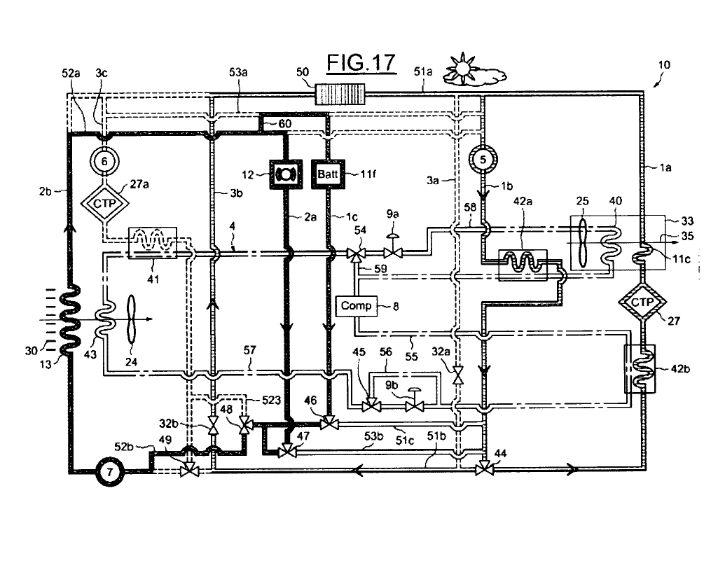

FIG. 17 illustrates the heat regulation system of FIG. 11, in a second summer operating mode;

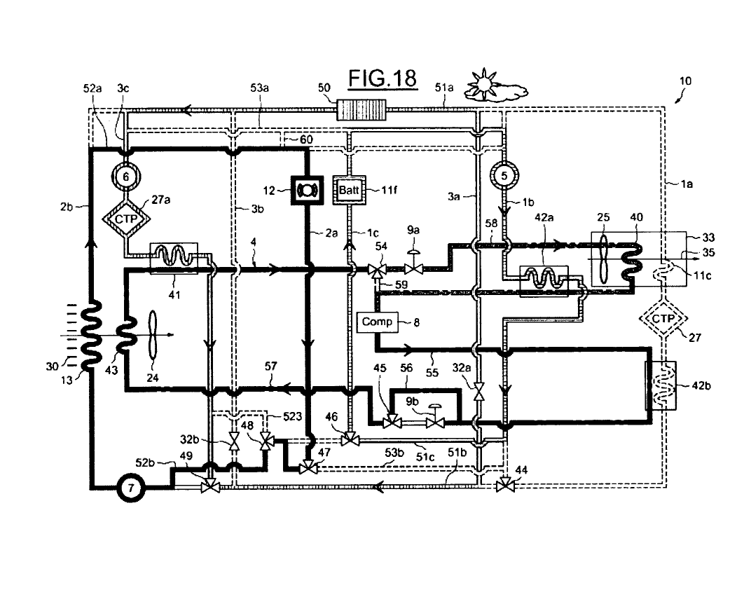

FIG. 18 illustrates the heat regulation system of FIG. 11, in a third summer operating mode;

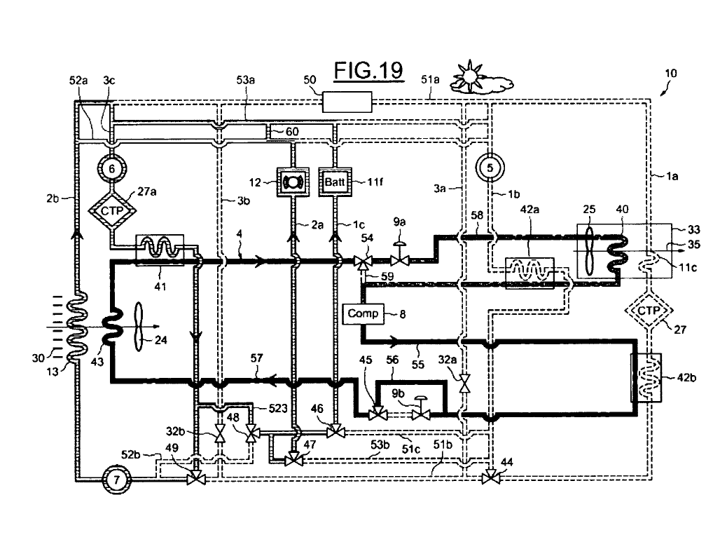

FIG. 19 illustrates the heat regulation system of FIG. 11, in a fourth summer operating mode;

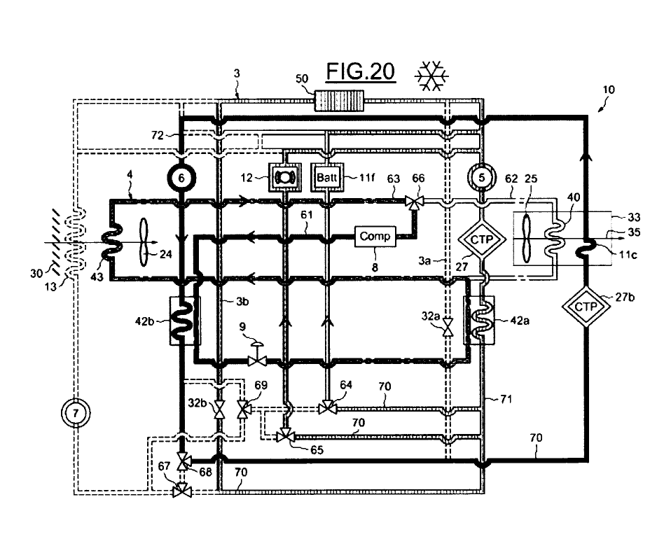

FIG. 20 illustrates a third heat regulation system according to the invention, in one of its winter operating modes; and

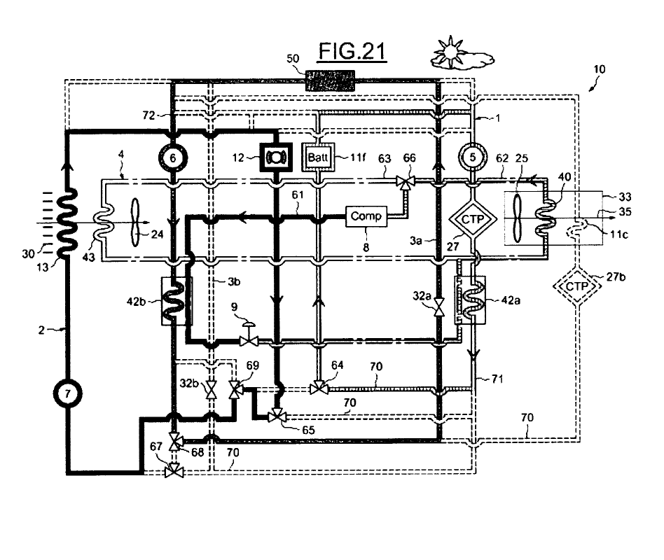

FIG. 21 illustrates the heat regulation system of FIG. 20, in one of its summer operating modes.

In FIGS. 1 to 21, the “snowflake” (respectively “sun”) pictogram alongside the figure number is a reminder that the operating mode represented is a winter (respectively, summer) operating mode.

As illustrated in FIG. 3, a heat regulation system according to the invention comprises a climate control circuit 4 and three independent fluid circuits 1, 2, and 3, all three passed through by a same heat-transfer fluid, for example glycol water. The climate control circuit 4 comprises two half-loops 28 and 29 of lines which are passed through by a refrigerant, for example a fluorinated and/or chlorinated derivative of methane or of ethane (Freon), a hydrocarbon, ammonia, carbon dioxide, etc.

By convention, in FIGS. 1 to 21, portions of lines represented with a white background schematically represent lines where the circulation of fluid is stopped.

By convention, in FIGS. 1 to 21, portions of lines capable of transporting a same type of fluid (either refrigerant or heat-transfer fluid), whose width has a black or shaded background (shading can be dotted lines) schematically represent lines in which fluid is circulating. The black background, or each type of shading, then each symbolizes a different fluid temperature. Two lines transporting fluids of different types, and represented with the same black background, or with the same type of shading, are not necessarily, however, at the same temperature.

The half-loops 28 and 29 are linked on the one side by a thermostatic expansion valve 9, and on the other side by a compressor 8, to which they are connected by a switchover valve 14. The half-loop 28 passes through a first condenser-evaporator 41. The half-loop 29 passes through a second condenser-evaporator 42. The arrows along the circuit 4 indicate the direction of circulation of the refrigerant. The refrigerant passes through the compressor always in the same direction, or from left to right in the illustration of FIG. 3. Depending on the position of the switchover valve 14, the refrigerant may pass through the circuit 4 in the clockwise direction or in the counter-clockwise direction.

Conventionally, the refrigerant vaporizes after having passed through the thermostatic expansion valve 9, by taking heat from the condenser-evaporator which it then passes through, here the condenser-evaporator 41, which serves as cold source with respect to the heat-transfer fluid that is to be cooled. The compressor 8 sucks in the vaporized fluid and discharges it to the condenser-evaporator of the other half-loop where it condenses by releasing heat, here the condenser-evaporator 42, which serves as heat source with respect to the heat-transfer fluid that is to be reheated.

The compressor 8 may be driven by the electric engine of the vehicle, or else be provided with its own electric motor, or else be a hybrid compressor, or else be a compressor driven by a heat engine of the vehicle.

The first independent fluid circuit 1 comprises a pump 5 which sends the fluid through a nonreturn valve 26 toward a condenser-evaporator 42. After having passed through the condenser-evaporator 42, the heat-transfer fluid passes through a three-way valve 15 either toward a heating branch Ic or toward a cooling branch If. The branches Ic and If then join to bring the heat-transfer fluid to the pump 5. The arrows arranged along the lines of the circuit 1 indicate the direction of circulation of the heat-transfer fluid. Each of the branches Ic and If includes a heat exchanger, respectively 11e and 11f, both situated inside a passenger compartment 33 of the vehicle, used to transfer heat, respectively refrigeration, from the heat-transfer fluid circuit 1 to the air of the passenger compartment. In order to improve the heat exchangers between the circuit 1 and the air of the passenger compartment, a fan 25 is used to draw air from the passenger compartment through heat exchangers 11e and 11f.

The use of two separate exchangers for heating and cooling makes it possible to limit the window misting problems which can in particular occur if hot heat-transfer fluid is sent into an exchanger which has previously been used to cool the passenger compartment and on which water has condensed.

In the configuration of FIG. 3, the condenser-evaporator 42 which serves as hot source for the climate control circuit 4 transfers heat to the heat-transfer fluid which is then sent to the heat exchanger 11e in order to reheat the air of the passenger compartment. A PTC heating element 27 is arranged on the path of the circuit 1 so as to be able to reheat the heat-transfer fluid of this circuit in addition to or independently of the heat provided by the condensers-evaporators 42. This PTC element is inactive in FIG. 3. It may, according to the variant embodiments, be replaced by another heating device, for example by a heat pump (not represented). The second heat regulation circuit 2 comprises a pump 7 which sends the heat-transfer fluid through a three-way valve to a heat exchanger 12 used to condition the temperature of an electric engine, for example an electric engine used to propel the vehicle, and/or used, according to other variant embodiments, to condition the temperature of any other electric or electronic component (charger, accumulator battery, power electronic component).

The heat-transfer fluid is then directed from this heat exchanger 12 to a radiator 13 comprising a heat exchanger between the heat-transfer fluid and the air which passes through this radiator, a fan 24 for drawing the air through the radiator, and a system of shutters 30 for limiting the flow of air through the radiator and thereby improving the aerodynamics of the vehicle.

The third heat regulation circuit 3 comprises a pump 6 which sends the heat-transfer fluid through the condenser-evaporator 41, via which the third circuit 3 may exchange heat or refrigeration with the climate control circuit 4.

After having passed through the condenser-evaporator 41, the heat-transfer fluid passes through a three-way valve 17, then a three-way valve 16, and is reinjected into the pump 6. A bypass line 31, which can be opened or closed by means of a valve 32, can be used to bring the heat-transfer fluid directly from upstream of the pump 6 to a point situated between the two three-way valves 16 and 17, without passing either through the pump 6 or through the condenser-evaporator 41.

In the regulation circuits 2 and 3, as in the regulation circuit 1, the directions of circulation of the heat-transfer fluid are indicated by arrows arranged along the lines. A line 19 is arranged between the three-way valve 16 of the circuit 3 and the upstream side of the condenser-evaporator 42 of the circuit 1.

Thus, depending on the configurations of the three-way valve 16, the heat-transfer fluid arriving from upstream of this valve 16 may be directed either directly to the pump 6, or through the condenser-evaporator 42, from the three-way valve 15, from one of the two heat exchangers 11e or 11f, before finally returning to the pump 6, through a line 20 arranged downstream of the branches 1c and 1f of the circuit 1, and arranged between the upstream side of the pump 5 and the upstream side of the pump 6.

A section restriction 21 may be arranged on the circuit 3 between the three-way valve 16 and the line 20, in order to ensure a balancing of the fluid flow rates between the different heat-transfer fluid circuits.

A line 22 is arranged between the three-way valve 17 of the circuit 3 and the three-way valve 18 of the circuit 2. This line enables all or part of the heat-transfer fluid from the condenser-evaporator 41 to flow toward the heat exchanger 12 used to condition the temperature of the electric engine.

A line 23 links the downstream side of the heat exchanger 12 of the electric engine to the upstream side of the pump 6 of the circuit 3. This line 23 enables all or some of the heat-transfer fluid coming from the heater exchanger 12 of the engine to flow through the pump 6. In the configuration described in FIG. 3, the three-way valves, 16, 17 and 18 are set so as to allow the circulation of heat-transfer fluid neither in the line 19 nor in the line 22. An independent circulation of heat-transfer fluid is then established for each of the circuits 1, 2 and 3, without the passage of heat-transfer fluid or with a minimal passage of heat-transfer fluid in the lines 20 and 23.

In practice, since the fluid in the lines 20 and 23 flows between the circuit 1 and the circuit 3, respectively between the circuit 2 and the circuit 3, there would be a tendency for example to increase the total quantity of liquid present in the circuit 3, which is not permitted by the construction of this circuit and by the incompressibility of the liquid.

In the configuration of FIG. 3, the heat regulation circuit 2 operates as a conventional cooling circuit for an engine, electric or not, the pump 7 circulating the heat-transfer fluid successively in the engine conditioning heat exchanger 12, and in the heat exchange radiator 13 exchanging heat with the air outside the engine. Heat released by the engine to the heat-transfer fluid in the exchanger 12 can therefore then be released by the heat-transfer fluid to the outside air drawn by the fan 24, at the radiator 13. The shutters 30 of the radiator are open.

The circuit 1 operates as a heating circuit, bringing the heat from two hot sources which are the condenser-evaporator 42 and possibly the PTC resistor 27, to the heat exchanger 11e passed through by the air of the passenger compartment 33 drawn by the fan 25. In the exemplary embodiment of FIG. 3, the PTC 27 is inactive. The heat-transfer fluid of the circuit 1 is propelled by the pump 5.

The regulation circuit 3 serves, in FIG. 3, as cold source through the condenser-evaporator 41, heat being taken by the climate control circuit 4 from the regulation circuit 3 to then be released to the circuit 1 at the condenser-evaporator 42. The climate control circuit 4 therefore operates as a heat pump. The efficiency of such a heat pump is all the more advantageous when the temperature difference between the cold source, that is to say the temperature of the heat-transfer fluid passing through the circuit 3, and the hot source, that is to say the temperature of the heat-transfer fluid passing through the circuit 1, is small.

We will now describe, with reference to FIGS. 1 to 10, different operating modes of the regulation system of FIG. 3. FIGS. 1 to 10 contain elements in common with FIG. 3, and the same elements are then given the same references.

In the operating mode described in FIG. 1, the vehicle (not represented) is connected to an outside electricity network (not represented) in order to recharge the electric battery (not represented). The energy of the electricity network is also used to raise the temperature of the heat-transfer fluid of the circuit 1 by means of the PTC resistor 27. The valves 16 and 17 are set so as to interconnect the circuit 1 and the circuit 3, by isolating the circuits 1 and 3 from the circuit 2. The heat-transfer fluid therefore circulates in the circuits 1, 3 and in the lines 19 and 20.

The climate control circuit 4 is inactive, like the circuit 2 and its pump 7. The valve 15 is set so that the heat-transfer fluid is sent into the heat exchanger 11e and so that the circulation of the heat-transfer fluid is stopped in the exchanger 11f. The circulation of the heat-transfer fluid is ensured by the pumps 5 and/or 6. The heat produced by the PTC resistor and conveyed by the heat-transfer fluid passing through the exchanger 11e are used to raise the temperature of the passenger compartment by actuating the fan 25. Once the desired passenger compartment temperature is obtained, the fan 25 can be deactivated, and/or restarted by time intervals to maintain the temperature of the passenger compartment at its set point value. During this time, the temperature of the heat-transfer fluid contained in the circuits 1 and 3 continues to be reheated by the PTC element for example up to a temperature determined by the boiling point temperature of the liquid and/or by the thermal resistances of the lines. By virtue of the high specific heat of the heat-transfer fluid and the consequential volume of liquid contained in the circuits 1 and 3, in particular in the circuit 3, a quantity of energy is thus stored, in the form of specific heat, which will not have to be taken from the battery to heat the passenger compartment. The circuit 3 may be provided with a tank of heat-transfer fluid (not represented), that is to say, a storage volume for locally storing, on a given linear length, the equivalent of several equivalent lengths of line of the circuit. This tank may be thermally insulated. The addition of such a tank makes it possible to increase the total quantity of liquid of the circuit 3. The thermal insulation of the outer surface of the tank makes it possible, with reduced insulation surface area, to substantially limit the heat losses of the liquid per unit of volume of the liquid. Certain portions of lines of the circuit 3, or of the other heat-transfer fluid circuits, may also be thermally insulated.

Once the heat regulation system 10 has been preconditioned in temperature, for example according to the operating mode corresponding to FIG. 1, the vehicle can be disconnected from the outside electricity network and can begin to run by placing the heat regulation system 10 in the configuration corresponding to FIG. 2. In this configuration, as in the configuration of FIG. 3, the regulation circuit 2 operates as an independent circuit, the pump 7 causing the heat-transfer fluid to pass through the electric engine conditioning exchanger 12, then through the radiator 13, cooled by the outside air drawn by the fan 24 through the open shutters 30.

In FIG. 2, the climate control circuit 4 is deactivated. The three-way valve 15 is set so as to send the heat-transfer fluid into the branch 1c of the circuit 1 and through the heat exchanger 11e intended to heat the passenger compartment. The PTC resistor 27 is deactivated. The three-way valve 16 is set so as to allow the passage of heat-transfer fluid through the line 19, and to stop the circulation of heat-transfer fluid through the restriction 21. The regulation circuits 1 and 3 are thus interconnected, the circulation of the heat-transfer fluid being ensured by the pumps 5 and 6. It would also be possible to envisage ensuring the circulation of fluid only with a single one of the two pumps. The heat-transfer fluid contained in the circuits 1 and 3 can thus progressively release, to the air of the passenger compartment, through the heat exchanger 11e, the stored heat energy. In order to also exploit the heat stored in the branch of the circuit 3 passing through the restriction 21, it is possible, by time intervals determined by the regulation system, to vary the setting of the three-way valve 16 in order to allow the circulation of the liquid of this branch.

In this configuration, the only electrical energy consumed to condition the temperature of the passenger compartment 33 is the energy needed to actuate the pump or pumps 5 and 6, plus, possibly, the electrical energy needed to actuate the fan 25.

The intensity of the heat exchanges with the passenger compartment can, for example, be regulated by modifying, by means of the pumps 5 and 6, the flow rate of heat-transfer fluid through the exchanger 11e, and by modifying, by means of the fan 25, the flow of air through this same exchanger. This operating mode can be maintained as long as the temperature of the heat-transfer fluid remains greater than the desired temperature of the air of the passenger compartment, plus a certain temperature difference needed for the heat exchanges between the heat-transfer fluid and the air of the passenger compartment to take place at a satisfactory speed, and to allow for the other heat losses resulting in a cooling of the air of the passenger compartment to be compensated.

When the temperature of the heat-transfer fluid becomes too close to that of the air of the passenger compartment, then when it becomes slightly less than this temperature of the air of the passenger compartment, the heat regulation system 10 can be actuated according to the operating mode corresponding to FIG. 3.

In this configuration of FIG. 3, the PTC resistor 27 remains inactive, and the regulation circuit 2 continues to operate independently to cool the electric engine by means of the radiator 13. The refrigerating circuit 4 is active, the switchover valve 14 being set so that the condenser-evaporator 41 operates as cold source and the condenser-evaporator 42 operates as hot source. The three-way valve 15 is always set so as to send the heat-transfer fluid through the branch 1c of the circuit 1 and the heat exchanger 11e intended to heat the passenger compartment. The three-way valve 16 is set so as to prevent the circulation of heat-transfer fluid through the line 19. The regulation circuits 1 and 3 therefore operate in a decoupled manner, that is to say, with no exchange of heat-transfer fluid between the two circuits. The circulation of the fluid in the circuit 1 is ensured by the pump 5, the circulation of the liquid in the circuit 3 is ensured by the pump 6.

The fan 25 may possibly be actuated so as to increase the heat exchanges between the heat-transfer fluid of the circuit 1 and the air of the passenger compartment. The air conditioning circuit 4 operates here as a heat pump, taking heat from the heat-transfer fluid of the circuit 3 and transferring it to the heat-transfer fluid of the circuit 1. Since the temperature of the liquid of the circuit 3 remains at this stage greater than that of the outside air and greater than that of the circuit 2, the efficiency and the performance of the heat pump consisting of the circuit 4 remain more advantageous than those of a heat pump for which the cold source would be the outside air, or would be the cooling circuit 2 of the electric engine. The electrical consumption needed to continue to maintain the air of the passenger compartment at a satisfactory level is thus limited. Furthermore, the heat pump makes it possible, in the configuration described, to ensure the heating of the passenger compartment even for very low outside temperatures, that is to say, temperatures at which a heat pump for which the cold source would be the outside air, or would be the circuit 2, would no longer be sufficient, and at which a top-up PTC resistor would then become necessary. Now, the efficiency of a PTC resistor is significantly less advantageous than that of a heat pump. Variant embodiments can be envisaged which would comprise a PTC (a PTC resistor) on the circuit 3, this PTC being used to slow down the gradual cooling of the heat-transfer fluid of the circuit 3. Such a PTC on the circuit 3 can replace the PTC 27 of the circuit 1 and be used for the preheating step described in FIG. 1. It is also possible to envisage variant embodiments in which there are two PTCs, the PTC 27 on the circuit 1 and a second PTC on the circuit 3, which makes it possible to make do with a PTC of lower power to maintain the temperature of the circuit 3 in the configuration of FIG. 3.

FIG. 4 illustrates a winter operating mode similar to that of FIG. 3, and which can, for example, be applied following the latter. In FIG. 4, the three-way valves 17 and 18 are set so as to allow the circulation of the heat-transfer fluid in the lines 22 and 23, and to block the circulation of fluid arriving from the radiator 13. The pump 7 is inactive, as is the fan 24. The shutters 30 may possibly be closed to improve the aerodynamics of the vehicle. The regulation circuits 1 and 3 continue to operate as two independent circuits not exchanging any heat-transfer fluid. The electric engine temperature conditioning heat exchanger is connected to the regulation circuit 3. This configuration is recommended when the temperature of the heat-transfer fluid of the circuit 3 has become low enough to be able to ensure a sufficient cooling of the electric engine cooled by the exchanger 12. By virtue of this configuration, heat recovered from the electric engine can be exploited by means of the climate control circuit 4. The temperature difference between the cold source and the hot source of the climate control circuit is thus limited, and the efficiency of said climate control circuit is improved.

FIG. 5 illustrates another configuration of the heat regulation system 10 of FIGS. 1 to 4, that can, for example, be adopted after having passed through a configuration of the type of that of FIG. 3 or of FIG. 4, once the temperature of the heat-transfer fluid of the circuit 3 has fallen below a certain threshold. In the configuration of FIG. 5, the regulation circuit 1 continues to operate as an independent circuit as in the configurations of figures and 4. The PTC resistor 27 is inactive, the heat-transfer fluid passes through the heat exchanger 11e, and the fan 25 can be speed-controlled according to the desired degrees of heat exchange between the heat-transfer fluid and the air of the passenger compartment 33. The climate control circuit 4 continues to operate as a heat pump, between the condenser-evaporator 41 serving as cold source and the condenser-evaporator 42 serving as hot source. The regulation circuit 3 is deactivated, that is to say that the three-way valves 16 and 17 are configured so as to allow the passage of heat-transfer fluid only in the branch of the circuit 3 comprising the pump 6 and the condenser-evaporator 41. The three-way valves 17 and 18 are configured so as to couple the circulation of this branch with the circulation of heat-transfer fluid of the regulation circuit 2. The regulation circuit 2 then comprises the pump 7, the electric engine conditioning heat exchanger 12, the radiator 13, the pump 6 and the condenser-evaporator 41.

Using only one of the two pumps 6 and 7 to propel the heat-transfer fluid in this circuit can possibly be envisaged.

In the configuration of FIG. 5, as in that of FIG. 4, the heat released by the electric engine are used to improve the efficiency of the heat pump which constitutes the climate control circuit 4. Compared to the configuration of FIG. 4, the volume of heat-transfer fluid reheated by the heat from the electric engine is smaller, which makes it possible to reheat the heat-transfer fluid of the circuit 2 to a higher temperature than the temperature that would be obtained by distributing the heat from the engine over a volume of heat-transfer fluid corresponding, for example, to the volume of the circuit 3. The temperature of the circuit 2 must, however, be maintained below a maximum level, determined by the maximum operating temperature of the electric engine. When this temperature of the circuit becomes too high, the fan 24 can be actuated and the shutters 30 opened. If, however, this temperature is sufficiently low, it is possible to close the shutters 30 and deactivate the fan 24, which makes it possible to recover a maximum amount of heat released by the electric engine in favor of the operation of the climate control circuit 4. It is also possible, in the latter case, to actuate the three-way valve 18 to prevent the circulation of heat-transfer fluid in the radiator 13 and in the pump 7. The heat-transfer fluid of the circuit 2 then circulates only in the exchangers 12 and 41, propelled by the pump 6.

FIG. 6 illustrates a possible mode of operation of the heat regulation system 10 when the vehicle is stopped, connected to an outside electricity network in order to recharge its battery, and when the outside temperature (for example in summer) is higher than the temperature that the passengers want in the passenger compartment. The three-way valve 15 is this time set so as to make the heat-transfer fluid of the circuit 1 pass through the branch 1f and the heat exchanger 11f intended to cool the passenger compartment 33. The three-way valve 16 is in the same configuration as that of FIG. 1, thus providing couplings between the regulation circuits 1 and 3, through the lines 19 and 20. The valve 32 of the bypass circuit 31, which was closed in FIGS. 1 to 5, is here open, allowing the arrival of heat-transfer fluid from the circuit 1 through the three-way valve 16 to the bypass circuit 31. The three-way valve 17 is in the same configuration as in FIG. 5, thereby excluding the branch including the pump 6 and the condenser-evaporator 41 of the circuit 3, and, on the other hand, coupling this branch to the regulation circuit 2. The three-way valve 18 is set so as to allow the circulation from the condenser-evaporator 41 to the radiator 13 but prevent the circulation of heat-transfer fluid to the electric engine conditioning heat exchanger 12.

The circulation of heat-transfer fluid in the circuit 2 can, for example, be ensured by the pump 6, the pump 7 being deactivated. The shutters 30 of the radiator are open and the fan 24 is actuated so as to allow a cooling of the heat-transfer fluid of the circuit 1 by virtue of the flow of outside air passing through the radiator 13. The climate control circuit 4 operates in air conditioning mode, that is to say that the switchover valve 14 is set so as to use the condenser-evaporator 42 as cold source and the condenser-evaporator 41 as hot source. The climate control circuit 4 therefore takes heat from the coupled circuits 1 and 3 and discharges this heat to the circuit 2, whose temperature it raises. The fan 25 can be actuated initially until the air of the passenger compartment drops to the temperature desired by the passengers, then be cut, at least for time intervals, while the climate control circuit 4 continues to be actuated until the temperature of the two coupled circuits 1 and 3 drops to a minimum temperature allowed by the risks of thickening of the heat-transfer fluid and/or the cold resistance of the lines. As much refrigeration as possible is thus stored in the heat-transfer fluid circulating in the circuit 3, and possibly circulating in the storage tank (not represented) of the circuit 3.

Once this minimum temperature is reached, the fan 24 and the pump 6 can continue to be actuated for a moment, in order to return the temperature of the circuit 2 to a value close to that of the ambient air. Following these operations, refrigeration has been stored on the two loops 1 and 3, which, when the vehicle is running, will be able to be used to cool the passenger compartment and possibly to cool the electric units, without taking energy from the battery of the vehicle.

FIG. 7 describes an operating mode that is relatively similar to the operating mode of FIG. 2, that is to say that the regulation circuit 2 operates independently to cool the electric engine by means of the exchanger 12, the heat-transfer fluid passing in succession through the pump 7, the heat exchanger 12 and the radiator 13, the shutters 30 being open and the fan 24 being able to be actuated according to the cooling needs of the engine. The three-way valve 16 is again configured so as to couple the circulation of heat-transfer fluid of the circuits 1 and 3 through the lines 19 and 20. The three-way valve 15 is configured so as to send the heat-transfer fluid through the branch 1f of the circuit 1 and the heat exchanger 11f intended to cool the air of the passenger compartment. The fan 25 can be activated or not depending on the cooling needs of the air of the passenger compartment.

The valve 32 and the three-way valves 17 and 18 are set so as to exclude the branch comprising the pump 6 and the condenser-evaporator 41 of the circuit 3, and, on the contrary, to allow the circulation of heat-transfer fluid through the bypass circuit 31. It should be noted that it is possible to envisage variants of operation according to FIG. 7, which would allow the passage of the heat-transfer fluid in this branch comprising the pump 7 and the condenser-evaporator 41, instead of passing through the bypass circuit 31. Similarly, it is possible to envisage variant operating modes according to FIG. 2, in which the heat-transfer fluid of the circuit 3, instead of passing through the pump 6 and the condenser-evaporator 41, would pass through the bypass circuit 31. The climate control circuit 4 is deactivated. The cooling of the air of the passenger compartment is ensured by means of the refrigeration released by the heat-transfer fluid of the circuits 1 and 3 through the heat exchanger 11f, the intensity of these heat exchanges being able to be regulated on the one hand by modifying the flow rate of the heat-transfer fluid imposed by the pump 5, and on the other hand by modulating the air flow rate passing through the exchanger 11f by means of the fan 25.

In this operating mode, keeping the appropriate temperature of the air of the passenger compartment therefore requires only the electrical energy needed to actuate the pump 5 and the fan 25.

FIG. 8 illustrates an operating mode of the heat regulation system 10 which can be used in summer when the temperature of the heat-transfer fluid of the circuits 1 and 3 is still sufficiently low to ensure the cooling of the air of the passenger compartment, and the outside air is at a temperature that is too high to ensure, by means of the regulation circuit 2, a satisfactory cooling of the electric engine (and/or, according to the variants, of the accessories of the engine (charger, electronic components) and/or of the battery).

The configuration of FIG. 8 differs from the configuration of FIG. 7 in that the valve 32 of the bypass circuit 31 is closed, and in that the three-way valves 17 and 18 are set to allow the passage of the fluid of the circuit 3 in the electric engine temperature conditioning heat exchanger 12. The refrigeration stored in the heat-transfer fluid of the circuits 1 and 3 is therefore released, partly at the exchanger 11f to the air of the passenger compartment and partly at the exchanger 12 to the electric engine.

FIG. 9 illustrates a summer operating mode of the heat regulation system 10, which is similar in its broad outlines to the winter operating mode described in FIG. 3. The regulation circuit 2 operates as an independent circuit, the pump 7 propelling the heat-transfer fluid through the internal combustion engine conditioning exchanger 12 then through the radiator 13 passed through by the outside air drawn by the fan 24. The three-way valves 16 and 17 are set to impose a separate circulation of heat-transfer fluids for the circuit 1 and for the circuit 3. In the circuit 3, the valve 32 is closed. Unlike in FIG. 3, the three-way valve 15 is in a setting which forces the heat-transfer fluid to pass into the branch 1f of the circuit 1, and into the exchanger 11f, intended to cool the air of the passenger compartment.

Each of pumps 5, 6 and 7 ensures the circulation of the heat-transfer fluid respectively in one of the regulation circuits 1, 3 and 2. The switchover valve 14 is in a setting opposite to that of FIG. 3, so as to make the condenser-evaporator 41 operate as heat source for the climate control circuit 4 and to make the condenser-evaporator 42 operate as cold source for this climate control circuit 4. The climate control circuit 4 therefore operates as a conventional air conditioning system for cooling the air of the passenger compartment, this air conditioning circuit however having a hot source with a temperature less high than that of the outside air, which makes it possible to improve the efficiency of the circuit and to reduce the electrical consumption.

This operating mode is advantageous when, after having stored refrigeration in the circuits 1 and 3 according to the operating mode of FIG. 6, the heat-transfer fluid of the circuits 1 and 3 has been gradually reheated to a temperature too close to that of the air of the passenger compartment, or even higher than that of the air of the passenger compartment, while still remaining cooler than that of the temperature of the air outside the vehicle. The operating mode described in FIG. 9 then makes it possible to use the climate control circuit 4 as air conditioning system, with a more advantageous efficiency than if this air conditioning system were using the outside air as hot source.

FIG. 10 illustrates another operating mode of the heat regulation system 10, which can be implemented when the vehicle is travelling on a hot summer's day and, after having used the operating modes of FIGS. 6 to 9, the temperature of the heat-transfer fluid of the circuit 3 has become comparable to that of the heat-transfer fluid of the circuit 2, that is say that the temperature of the heat-transfer fluid of the circuit 3 is still below that of the temperature of the heat-transfer fluid of the circuit 2, but that the difference between these two temperatures is below a deviation threshold. The operating mode of FIG. 10 is almost identical to the winter operating mode described in FIG. 5, apart from the fact that the switchover valve 14 is in the setting which makes the refrigerant of the circuit 4 circulate so as use the condenser-evaporator 41 as hot source and to use the condenser-evaporator 42 as cold source, and the fact that the three-way valve 15 is set so as to send the heat-transfer fluid of the circuit 1 into the branch 1f and the heat exchanger 11f instead of sending this heat-transfer fluid into the branch 1c.

On the other hand, by contrast to the operating mode of FIG. 5, in which the temperature that was to be imposed on the heat-transfer fluid of the circuit 2 was the result of a trade-off between the cooling requirements of the electric engine and the efficiency of the refrigerating circuit 4, in the case of the operating mode of FIG. 10, there is an advantage in maintaining the temperature of the heat-transfer fluid of the circuit 2 at the coolest possible level. The shutters 30 of the radiator 13 are therefore left always open. A choice can be made to have the fan 24 operate or not, depending on whether the electrical consumption generated by this fan is compensated or not by the gain in efficiency obtained on the climate control circuit 4, and depending on the cooling requirements of the electric engine.

The regulation circuit 3 is deactivated, so there is a saving on the energy of the pump 6 needed to circulate the heat-transfer fluid in this circuit.

FIGS. 11 to 20 illustrate another embodiment of the invention with a climate control circuit 4 not provided with a switchover valve. The refrigerant therefore always circulates in the same direction in the lines of this climate control circuit. On the other hand, this climate control circuit 4 is provided, not with two, but with four heat exchangers 40, 42b, 43 and 41 and is provided with two expansion valves 9a, 9b, and two bypass lines 56 and 59. These bypass lines 56 and 59 can be opened or closed respectively by means of a three-way valve 45 and 54, allowing the refrigerant to circumvent one or other of the two expansion valves 9b, 9a, so as to be able to operate at least two heat exchangers, in this case the heat exchangers 41, 43, alternatively as cold source and as hot source.

As illustrated in FIG. 13, a heat regulation system 10 comprises a climate control circuit 4 provided with a compressor 8. The compressor 8 sends the refrigerant first of all into a first portion of circuit 55 passing through a heat exchanger 42b, an expansion valve 9b and a three-way valve 45. Depending on the position of the three-way valve 45, the refrigerant passes first of all through the exchanger 42b then the expansion valve 9b, or passes first of all through the exchanger 42b than a bypass line 56 circumventing the expansion valve 9b and culminating at the three-way valve 45. The refrigerant then passes through a second portion of circuit 57, passing in succession through a heat exchanger 43 and a heat exchanger 41, then a three-way valve 54. Depending on the position of the three-way valve 54, the refrigerant can then either return directly to the compressor 8 through a bypass portion 59, or pass through a third portion of circuit 58, passing in succession through an expansion valve 9a, then a heat exchanger 40 before returning to the compressor 8. The heat exchanger 40 is arranged in a passenger compartment 33 of the vehicle in order to allow heat exchanges between the refrigerant of the circuit 4 and the air of the passenger compartment drawn through the exchanger 40 by means of a fan 25. The heat exchanger 43 is arranged outside the passenger compartment 33 of the vehicle and is in contact with the air outside the vehicle, drawn through this exchanger by the forward motion of the vehicle and/or drawn by means of a fan 24. The exchangers 41 and 42b are arranged outside the passenger compartment 33, so as to allow a heat exchange between the refrigerant of the climate control circuit 4 and a heat-transfer fluid circulating in other lines of the heat regulation system 10. The heat regulation system 10 comprises an assembly of interconnected lines 1a, 1b, 1c; 3a, 3b, 3c; 2a, 2b; 51a, 51b, 51c; 52a, 52b, 53a, 53b, 523 in which a same heat-transfer fluid can circulate. The line 1a passes through the passenger compartment 33, in which it passes through a heat exchanger 11e, enabling heat to be exchanged between the heat-transfer fluid circulating in the line and the air of the passenger compartment drawn through the exchanger 11e by the fan 25.

On this line 1a, there is also arranged a PTC resistor used to reheat the heat-transfer fluid. The PTC resistor 27 may be located outside or inside the passenger compartment 33. The line 1a also passes through the heat exchanger 42b allowing heat to be exchanged between the heat-transfer fluid passing through the line 1a and the refrigerant of the climate control circuit 4. The heat exchanger 42b is located outside the passenger compartment 33. The line 1b is provided with a pump 5, which sends the heat-transfer fluid through a heat exchanger 42a, allowing heat to be exchanged between the heat-transfer fluid passing through the line, and the refrigerant of the climate control circuit 4. The line 1b rejoins the line 1a at a three-way valve 44 situated between the exchangers 42a and 42b. At their end opposite the three-way valve 44, the lines 1a and 1b are interconnected and are connected to three other lines 51a, 52a and 53a. The three-way valve 44 can be used to connect the ends of two or three out of the lines 1a, 1b and 51b. A line 3a, which can be opened or closed by means of a valve 32a, links the line 51b at its inlet into the three-way valve 44, and the upstream side of the pump 5. The line 51b links the three-way valve 44 and a three-way valve 49, the latter valve connecting the ends of the lines 51b, 2b and 3c. The line 2b includes a pump 7 capable of propelling the heat-transfer fluid from the three-way valve 49 to a heat exchange radiator 13 also situated along the line 2b. The radiator 13 allows heat exchanges between the heat-transfer fluid of the line 2b and the air outside the vehicle drawn through the radiator 13 by the fan 24. The radiator 13 can be provided with orientable shutters 30, making it possible to avoid the flow of air through the radiator, in order to improve the aerodynamics of the vehicle. The line 3c is provided with a pump 6 capable of propelling the heat-transfer fluid toward the three-way valve 49. On this line 3c, there is arranged a PTC resistor 27a, used to reheat the heat-transfer fluid passing through the line.

Downstream of the PTC resistor 27a, the line 3c passes through the heat exchanger 41, allowing heat to be exchanged between the heat-transfer fluid passing through the line and the refrigerant of the climate control circuit 4. The line 3c is linked at its upstream end relative to the pump 6, by means of the line 53a, to the line 1b upstream of the pump 5. The line 2b is linked at its upstream end relative to the pump 7, by means of the line 52a, to the end of the line 1b upstream of the pump 5. The line 3b links the upstream end, relative to the pump 7 of the line 2b, and the line 51b. The circulation of heat-transfer fluid in the line 3b can be stopped or enabled by a valve 32b. The lines 52a and 53a are linked substantially in their middle by a junction line 60. The line 51a links, in order, the downstream end of the line 2b (relative to the pump 7 and to the radiator 13), the end of the line 3b opposite the three-way valve 49, the end of the line 3a opposite the three-way valve 44, and the upstream end, relative to the pump 5, of the line 1b. On this line 51a, there may be arranged a tank 50 capable of containing a quantity of several liters of heat-transfer fluid, so that the heat-transfer fluid passes through the tank 50 when it circulates in the line 51a. Advantageously, this tank will be thermally insulated on its outer surface, so as to avoid heat exchanges between the heat-transfer fluid contained in the tank and the outside of the tank, and will, on the contrary, be arranged so as to favor heat exchanges between the heat-transfer fluid arriving in and leaving from the tank and the heat-transfer fluid present in the tank.

The line 2a is connected to the line 52a between the bypass portion 60 and the upstream side of the pump 5. This line 2a passes through a heat exchanger 12, making it possible to condition the temperature of an electric engine, and rejoins, at its end opposite the line 52a, a three-way valve 47. The line 1c is connected to the line 53a between the bypass section 60 and the upstream side of the pump 5. At its other end, the line 1c rejoins a three-way valve 46. The line 1c passes through a heat exchanger 11f, making it possible to condition the temperature of an electric power supply battery of the vehicle. The line 51c links the three-way valve 44 and the three-way valve 46. The line 53b links the three-way valve 44 and the three-way valve 47. A three-way valve 48 is linked by a first channel to the line 3c, between the heat exchanger 41 and the three-way valve 49. This three-way valve 48 is linked at a second way, through the line 52b, to the line 2b, between the pump 7 and the three-way valve 49. This three-way valve 48 is also connected at its third way, simultaneously to an inlet of the three-way valve 46 and to an inlet of the three-way valve 47.

FIG. 11 illustrates an operating mode of the heat regulation system of FIG. 13, which can be implemented when the vehicle is connected to an outside electricity network in order to recharge its battery, and the outside temperature is lower than that desired in the passenger compartment, for example in winter. In this configuration, the climate control circuit 4 is activated, the three-way valves 45 and 54 being set so as to not send refrigerant into the heat exchanger 40, or through the condenser-evaporator 42a, or through the expansion valve 9a, but, on the other hand, so that the refrigerant passes through the expansion valve 9b. In this configuration, the heat exchanger 43 operates as cold source for the climate control circuit 4 and the exchanger 42b operates as hot source for this same climate control circuit. The refrigerant of the circuit 4 passes through the compressor 8, then releases heat to the condenser-evaporator 42b by being liquefied, passes through the expansion valve 9b which lowers its pressure by vaporizing the refrigerant which then passes through the condenser-evaporator 43 where it is vaporized by taking heat from the outside air drawn by the fan 24, then passes through the condenser-evaporator 41 and takes a few more additional heat from the heat-transfer fluid passing through the line 3c, and returns to the compressor 8 through the three-way valve 54. The pump 7 is inactive. The valves 32a and 32b are closed. The three-way valves 44, 46, 47, 48, 49 are set so that the heat-transfer fluid passes only through the lines 51b, 1b, 51a, 3c and 1a. The circuit consisting of these lines comprises two loops, a first loop formed by the branch 1a and by the branch 1b, the circulation of fluid in this loop being ensured essentially by the pump 5, and a second loop consisting of the branches 1a, 51a, 3c and 51b, the circulation of the heat-transfer fluid in this loop being ensured essentially by the pump 6. It is possible to envisage using only one of the two pumps 5 and 6 to propel the liquid in this double loop. The heat-transfer fluid passing through this double loop is reheated at the condenser-evaporator 42b by the heat taken by means of the climate control circuit 4 from the air outside the vehicle. This heat-transfer fluid can also be reheated by operating the PTC resistor 27 in parallel with the heat pump circuit 4. By passing through the heat exchanger 11e through which the fan 25 draws the air of the passenger compartment 33, the heat-transfer fluid can be used to raise the temperature of the air of the passenger compartment, to the level desired for the departure of the vehicle. The heat thus taken by the climate control circuit 4, operating as heat pump, are accumulated in the heat-transfer fluid passing through the double loop, which comprises in particular the volume of heat-transfer fluid contained in the tank 50. After having stopped the fan 25, the temperature of the heat-transfer fluid can be raised to a desirable maximum value determined, for example, by the boiling point temperature of the heat-transfer fluid or by the resistor and the lines. It is possible to envisage another preconditioning mode for the heat regulation system 10 when recharging the battery in winter, for example by deactivating the climate control circuit 4, and by having the heat-transfer fluid circulate in the same lines as in FIG. 11, by activating only the PTC resistor 27.

FIG. 12 illustrates another operating mode of the regulation system 10 of FIG. 13, which can be used after the vehicle has been started, following a preconditioning step such as that described in FIG. 11. In FIG. 12, the climate control circuit 4 is deactivated. The double loop in which circulates the heat-transfer fluid consisting of the lines 1a, 51a, 3b, 51b and 1b continues to be actuated as in FIG. 11 by the pumps 5 and 6, the fan 25 being actuated according to the reheating needs of the air of the passenger compartment 33. The heat stored in this double loop, and notably in the tank 50, is gradually released by means of the heat exchanger 11e to reheat the air of the passenger compartment 33. A second circulation of heat-transfer fluid, independent of the circulation in the double loop, is ensured by the pump 7, which sends the heat-transfer fluid through the radiator 13, passed through by the air outside the vehicle drawn by the fan 24, then through the lines 1c and 2a, so as to pass through the heat exchanger 11f and the heat exchanger 12, thus simultaneously cooling the battery and the electric engine of the vehicle. The three-way valves 46, 47, 48 and 49 are set so as to then redirect toward the pump 7 the heat-transfer fluid that has passed through the exchangers 11f and 12. Section restrictions can, for example, be arranged on the lines 52a and 53a at the point where these lines rejoin the line 1b, so as to limit the risks of leaks of heat-transfer fluid from the cooling circuit thus delimited by the branches 1c, 2a and 2b, in the storage double loop delimited by the branches 1a, 1b and 3c. If these restrictions are correctly calibrated and the three-way valves 46, 47, 48 and 49 are in the appropriate setting, two independent circulations are established as in FIG. 12, on the one hand, for the heat storage double loop and on the other hand for the cooling circuit.

FIG. 13 illustrates an operating mode of the regulation system 10 of FIGS. 11 and 12, when, after the system has passed through the operating modes of FIGS. 11 and 12, the temperature of the heat-transfer fluid of the heat storage double loop has fallen below a threshold temperature, this temperature no longer making it possible to sufficiently reheat the air of the passenger compartment 33 through the heat exchanger 11e. The operating mode of FIG. 13 is comparable in principle to the operating mode described in FIG. 3.

The climate control circuit 4 is activated, and is in the same configuration as in FIG. 11, that is to say that the condenser-evaporator 42b is operating as hot source and the condensers-evaporators 43 and 41 are operating as cold sources. The branches 1c, 2a and 2b continue to be fed independently with heat-transfer fluid by the pump 7 through the radiator 13. The valve 32a is open and the three-way valves 44 and 49 are set in such a way that an independent heat-transfer fluid circulation loop is established through the lines 3c, 31b, 3a and 51a.

This loop, which comprises the tank 50, forms a heat storage loop containing a heat-transfer fluid at a higher temperature than the outside temperature but less high, or only just a little higher, than the temperature of the air of the passenger compartment. This heat storage loop serves as a reserve of heat as cold source for the climate control circuit 4 operating as heat pump. The efficiency of the system is thus improved compared to a heat pump which would directly use the outside air as cold source. The three-way valve 44 is set so as to allow an independent circulation of heat-transfer fluid to be established in the lines 1b and 1a, this circulation being ensured by the pump 5. This heat-transfer fluid circulation loop actuated by the pump 5 is used to transfer the heat received by the heat-transfer fluid at the condenser-evaporator 42b to the air of the passenger compartment through the heat exchanger 11e. The temperature of this circulation loop remains higher than that of the air of the passenger compartment. It will be noted that, in this embodiment, the climate control circuit 4 comprises two “staged” cold sources, in other words the refrigerant passes first of all through the condenser-evaporator 43 passed through by the outside air, where it is partly vaporized by taking heat from this outside air, then passes through the condenser-evaporator 41 where it continues to be vaporized by taking heat from the heat-transfer fluid of the heat storage circuit, the circulation of which is ensured by the pump 6. It is possible to delay the cooling of this heat storage circuit by activating the PTC resistor 27a.

FIG. 14 illustrates another operating mode of the heat regulation system of FIGS. 11 to 13, which can be applied instead of the operating mode of FIG. 13, for example when the temperature of the heat-transfer fluid passing through the heat storage circuit actuated by the pump 6 becomes sufficiently low to ensure a sufficient cooling of the electric engine by means of the heat exchanger 12. This operating mode is comparable to the operating mode described in FIG. 4 of the first embodiment of the invention. In FIG. 14, unlike FIG. 13, the pump 7 is inactive. The climate control circuit 4 is in the same configuration as in FIG. 13. The three-way valve 44 is set so as to allow an independent circulation, ensured by the pump 5, of a loop for reheating the air of the passenger compartment delimited by the lines 1a and 1b. The three-way valves and 48 are set so as to allow the passage of a portion of the heat-transfer fluid circulating to the pump 6 in the heat storage circuit comprising the lines 3a and 3c, in the branch 2a passing through the electric engine temperature conditioning heat exchanger 12. It would also be possible to envisage setting the three-way valve 46 so as also to transfer a portion of the heat-transfer fluid from this heat storage circuit into the branch 1c and into the battery temperature conditioning exchanger 11f. By virtue of the heat recovered in this way by the exchangers 11f and/or 12, the cooling of the heat storage circuit is delayed and the efficiency of the climate control circuit 4 operating as heat pump is improved.

FIG. 15 illustrates an operating mode of the regulation system 10 of FIGS. 11 to 14 which can be used in winter after having used one or more of the operating modes of FIGS. 11 to 14, and the temperature of the heat-transfer fluid present in the tank 50 becomes lower than a certain threshold.

This operating mode is similar in principle to the operating modes described in FIG. 5, that is to say that the climate control circuit 4 operates as heat pump in the configuration described for example in FIG. 14, the pump 5 feeds a circuit (or a loop) for reheating the air of the passenger compartment limited to the lines 1a and 1b. The circulation of the heat-transfer fluid is limited locally to this circuit by the setting of the three-way valve 44. The three-way valves 46, 47, 48 and 49 are set so as to exclude the tank 50 from the circulation of heat-transfer fluid. The valves 32a and 32b are closed. The setting of the three-way valves 46, 47, 48 and 49 is used to establish an independent circulation of the heat-transfer fluid in a cooling circuit comprising the line 2b passing through the radiator 13, the line 3c passing through the condenser-evaporator 41, the line 2a passing through the engine temperature conditioning heat exchanger 12, and the line 1c passing through the battery temperature conditioning heat exchanger 11f. The circulation of the heat-transfer fluid can be ensured by the pumps 6 and 7 or by just one of these two pumps.

The climate control circuit 4 operates as heat pump for which the cold sources are supplied on the one hand at the condenser-evaporator 43 by the air outside the vehicle, and on the other hand at the condenser-evaporator 41 by the heat-transfer fluid passing through the line 3c. The advantage of the configuration of FIG. 15 compared to that of FIG. 14 is that the total volume of the heat-transfer fluid of the circuit including the condenser-evaporator 41 is smaller, which results in a lesser “dilution” of the heat recovered on the electric engine and on the battery. Depending on the temperature of the outside air, the shutters 30 of the radiator 13 may be left open and the fan 24 started up, if the outside temperature is sufficiently high to allow for the recovery of additional heat, or, on the other hand, the shutters 30 may be closed to avoid heat exchanges at the radiator 13.

FIG. 16 illustrates an operating mode of the heat regulation system of FIGS. 11 to 15, this time in summer, when the outside temperature is higher than the temperature desired in the passenger compartment. This operating mode can be implemented when the vehicle is stopped, connected to an external electricity network in order to recharge its battery. The climate control circuit 4 is this time configured to operate in air conditioning mode with respect to the passenger compartment 33. The climate control circuit 4 uses the condenser-evaporator 43 as hot source and uses the condensers-evaporators 40 and 42a as cold source. To do this, the three-way valve 54 is set so as to allow the passage of refrigerant into the portion 58 of the circuit comprising the expansion valve 9a and the condenser-evaporator 40, and on the other hand to prevent the passage of refrigerant into the bypass portion 59. The three-way valve 45 is set so that the refrigerant circumvents the expansion valve 9b via the bypass portion 56.

The climate control circuit 4 rejects heat toward the air outside the vehicle drawn through the condenser-evaporator 43 by means of the fan 24. On the other hand, the climate control circuit 4 takes heat, on the one hand, from the air of the passenger compartment 33 drawn through the condenser-evaporator 40 by the fan 25, and on the other hand, from a heat storage circuit, the circulation of the heat-transfer fluid in this heat storage circuit being ensured by the pump 5. The heat storage circuit comprises in particular the pump 5 and the tank 50. The valve 32b is open, the valve 32a is closed, and the three-way valves 46, 47, 48, 49 are set so as to allow the circulation of the heat-transfer fluid in a double loop consisting on the one hand of the lines 1b, 51b, 3b, 51a and on the other hand of the lines 1b, 51c, 1c and 53a.

The line 1e passes through the battery temperature conditioning heat exchanger 11f. The heat taken from the heat storage circuit (in other words, the refrigeration released to the heat storage circuit) is used on the one hand to cool the heat-transfer fluid so as to have, after the vehicle is started, a reserve of “specific cold” that can be restored in particular to the air of the passenger compartment after the vehicle has started, and are used on the other hand to recool the battery during its recharging. They are also used to lower the temperature of the passenger compartment to the level desired for the departure of the vehicle, through the heat exchanger 40. If the outside temperature is not too high, it is possible to envisage, during the recharging of the battery, an operating mode similar to that described in FIG. 16, but in which the heat-transfer fluid would not be made to circulate in the branches 51b, 3b, 51a, and in the tank 50, and in which the fan 25 would not be actuated. The heat taken by the climate control circuit 4 would then essentially be taken from the condenser-evaporator 42a, and would be used to cool the battery by means of the exchanger 11f.

FIG. 17 illustrates an operating mode of the heat regulation system 10 of FIGS. 11 to 16, which can be used when the vehicle has just started after having performed a preconditioning step according to the operating mode described in FIG. 16. In FIG. 17, the climate control circuit 4 is deactivated, and the valves and the pumps of the heat-transfer fluid lines are all in exactly the same configuration as in the operating mode described in FIG. 12. However, in the operating mode of FIG. 17, it is refrigeration which is released to the air of the passenger compartment 33 when the heat-transfer fluid passes through the exchanger 11e, instead of the heat released in the operating mode of FIG. 12. The cold stored in the heat-transfer fluid therefore makes it possible to recool the air of the passenger compartment without using any electrical energy other than that needed to actuate the pump 5 and the fan 25.

FIG. 18 describes an operating mode of the heat regulation system 10 of FIGS. 11 to 17, which can be used when the vehicle is running in summer, after having used the operating modes described in FIGS. 16 and 17, when the temperature of the heat-transfer fluid present in the tank 50 is no longer cool enough to ensure the cooling of the air of the passenger compartment 33 by only the passage of the heat-transfer fluid in the exchanger 11e. The climate control circuit is activated in air conditioning mode, which means that it is in the same configuration as in FIG. 16, the condenser-evaporator 40 operating as cold source and cooling the air of the passenger compartment 33. The valve 32a is open, the valve 32b is closed. The three-way valves 46, 47, 48 and 49 are set so as to establish three independent heat-transfer fluid circulation loops. The first loop comprises lines 1b, 51c, 1c, 53a, the circulation of heat-transfer fluid in this loop is ensured by the pump 5. The heat is taken from this loop by the climate control circuit 4 through the condenser-evaporator 42a and are used to cool the battery through the heat exchanger 11f.

The second loop comprises the lines 2b, 52a, 2a, 52b, and the line between the three-way valves 47 and 48. The circulation of heat-transfer fluid in this loop is ensured by the pump 7. The heat-transfer fluid passes through the radiator 13 where it is cooled by the outside air drawn by the fan 24, then the electric engine temperature conditioning exchanger 12, before returning to the pump 7.

The third loop comprises the lines 51b, 3a, 51a and 3c. The circulation of heat-transfer fluid in this loop is ensured by the pump 6, and the heat exchanges between this loop and the climate control circuit 4 take place through the condenser-evaporator 41. The configuration of FIG. 18 may be advantageous as long as the temperature of the heat-transfer fluid present in the tank 50 remains lower than that of the heat-transfer fluid passing through the radiator 13, or than the temperature of the air outside the vehicle. In this configuration, the refrigerant vaporizes by taking heat from the condenser-evaporator 42a, passes through the compressor 8, passes through the condenser-evaporator 42b without notable heat exchange since the heat-transfer fluid does not circulate in the line 1a, then the refrigerant liquefies at the condenser-evaporator 43 by releasing heat to the outside air drawn by the fan 24, and can release additional heat at the condenser-evaporator 41. As long as the temperature of the heat-transfer fluid of the tank 50 remains lower than that of the air outside the vehicle, there is therefore a “cool” hot source making it possible to optimize the efficiency of the climate control circuit 4 compared to a climate control circuit in which the hot source would, for example, consist either of the circuit comprising the radiator 13 and the engine cooling loop, or consist of the air outside the vehicle.

FIG. 19 illustrates an operating mode of the heat regulation system 10 of FIGS. 1 to 18, which can be used in summer, for example when, after having passed through the operating mode of FIGS. 16 to 18, the temperature of the heat-transfer fluids present in the tank 50 has become higher than that of the air outside the vehicle. The climate control circuit 4 is in air conditioning mode, that is to say, in the same configuration as in FIG. 18, the valves 32a and 32b are closed, the three-way valves 46, 47, 48, 49 are set so as to establish a single common heat-transfer fluid circulation network, excluding the tank 50 and comprising the lines 1c, 2a, 3c, 2b.

The circulation of the heat-transfer fluid may be ensured by the pumps 6 and 7 or by one of the two pumps. The heat-transfer fluid passes through the engine temperature conditioning heat exchanger 12, through the battery heat conditioning heat exchanger 11f, taking heat released by the electric engine, by the battery, and also taking heat at the condenser-evaporator 41. The heat-transfer fluid is then cooled by passing through the radiator 13 passed through by the air drawn by the fan 24. The climate control circuit 4 has two hot sources: the condenser-evaporator 43 passed through by the air outside the vehicle drawn by the fan 24, and the condenser-evaporator 41 passed through by the heat-transfer fluid at a temperature that is a priori slightly higher than that of the outside air. Because of the higher specific heat of the heat-transfer fluid relative to the air, the second hot source consisting of the condenser-evaporator 41, although being at a higher temperature than the air passing through the condenser-evaporator 43, does, however remain advantageous for taking additional heat from the climate control circuit 4. The refrigerant is then vaporized by passing through the expansion valve 9a and the condenser-evaporator 40 to cool the air of the passenger compartment 33 passing through this condenser-evaporator. As in FIG. 18, the refrigerant then passes through the condenser-evaporator 42b without any notable heat exchange since the heat-transfer fluid does not circulate in the line 1a.

FIGS. 20 to 21 contain elements common to FIGS. 1 to 19, the same elements then bearing the same references. FIGS. 20 and 21 describe an embodiment of the invention in which a climate control circuit 4 is this time provided with a compressor 8 and a single expansion valve 9, and a condenser 42b operating as hot source and three evaporators 40, 42a and 43 always operating as cold source with respect to the climate control circuit 4. The climate control circuit 4 comprises a hot half-loop 61 linking the compressor 8 and the expansion valve 9 and passing through the condenser 42b. Upstream of the inlet of the compressor 8, there is a three-way valve 66 linked to the expansion valve 9 by two cold half-loops 62 and 63. The fluid arriving from the expansion valve 9 passes first of all through the evaporator 42a then, depending on the setting of the valve 66, passes through the half-loop 62 by passing through the evaporator 40, or passes through the half-loop 63 by passing through the evaporator 43. On arriving from the half-loop 62 or the half-loop 63, the refrigerant then passes through the three-way valve 66 and arrives at the compressor 8. The evaporator 43 is reheated by the air outside the vehicle drawn through the evaporator 43 by a fan 24. The evaporator 40 is arranged inside the passenger compartment 33 of the vehicle and is passed through by the air of the passenger compartment drawn by a fan 25. The evaporator 42a and the condenser 42b are passed through by the lines 71 and 72 of a network of lines 70 capable of transporting a same heat-transfer fluid, the circulation of the heat-transfer fluid in the network of lines 70 being ensured by one or more out of three pumps 5, 6 and 7.

In the network of lines, there are interposed, on three different lines, a heat exchanger 12 used to condition the temperature of an electric engine, a heat exchanger 11f used to condition the temperature of an electrical accumulator battery, and a heat exchange radiator 13 exchanging heat between the heat-transfer fluid and the air outside the vehicle. The radiator 13 is passed through by the outside air drawn by the fan 24, and is provided with mobile shutters 30. On two of the lines, there are valves 32a and 32b that can be used to stop or reestablish the circulation of heat-transfer fluid in the line. At five nodes of the network of lines, there are three-way valves 64, 65, 67, 68, 69 which can be used to establish heat-transfer fluid circulation loops, the circulation loops being able to be coupled or decoupled.

The pump 5 is located on the line 71 upstream of the evaporator 42a, the pump 6 is located on the line 72 upstream of the condenser 42b, the pump 7 is located on another line upstream of the radiator 13. In the configuration of FIG. 20, the three-way valve 66 of the climate control circuit 4 is set so as to send the refrigerant into the half-loop 63. The refrigerant does not therefore circulate in the half-loop 62 passing through the passenger compartment 33. A heat-transfer fluid circulation loop is established between the pump 6, the condenser 42b and the heat exchanger 11e arranged inside the passenger compartment 33. On this circulation loop there is also arranged a PTC resistor 27b which is here inactive. The heat taken from the refrigerating circuit 4 by the condenser 42b is released to the air of the passenger compartment drawn through the exchanger 11e by the fan 25. This heat is taken by the climate control circuit 4, on the one hand, at the evaporator 43 in contact with the air outside the vehicle, and, on the other hand, from the evaporator 42a through which the heat-transfer fluid arriving from three coupled circulation loops passes. One of these loops passes through the engine temperature conditioning heat exchanger 12, the other passes through the battery temperature conditioning heat exchanger 11f, and the third passes through a heat-transfer fluid storage tank 50. The operating mode described in FIG. 20 is a winter operating mode which makes it possible to heat the temperature of the passenger compartment by recovering the heat released by the electric engine and by the battery, and by exploiting heat previously stored in the heat-transfer fluid present in particular in the tank 50. Depending on the temperature of the outside air, the shutters 30 of the radiator 13 may be open or closed, and the fan could be activated or deactivated in order to use only the evaporator 42a as cold source or to use both the evaporators 42a and 43 simultaneously as cold source.

FIG. 21 describes an operating mode of the heat regulation system 10 of FIG. 20, which can be used in summer when the temperature desired in the passenger compartment is lower than the temperature outside the vehicle. This operating mode can be used after having performed a system preconditioning step, for example while the vehicle is connected to an outside electricity network in order to recharge its battery, and having lowered the temperature of the heat-transfer fluid present in the tank 50 to a temperature lower than the temperature outside the vehicle. In the configuration of FIG. 21, the pump 7 is active, the valve 32b is closed, the valve 32a is open and the three-way valves 64, 65, 67, 68, 69 are configured so as to establish an independent heat-transfer fluid circulation loop from the pump 7 to the engine temperature conditioning heat exchanger 12, then to the heat exchange radiator 13 exchanging heat with the air outside the vehicle. The shutters 30 of the radiator are open and the fan 24 draws the outside air through the radiator 13. The three-way valves are also set so as to allow for the establishment of another independent heat-transfer fluid circulation loop, going from the pump 6 to the condenser 42b then to the heat storage tank 50, before returning again to the pump 6.

Another independent heat-transfer fluid circulation loop is established from the pump 5 by passing through a PTC resistor 27, then through the evaporator 42a, then through the battery temperature conditioning heat exchanger 11f, before returning to the pump 5. The valve 66 of the climate control circuit 4 is set so as to send the refrigerant through the half-loop 62 and the passenger compartment 33, through which the refrigerant passes through the evaporator 40, after having passed initially through the evaporator 42a. The refrigerant does not therefore circulate in the half-loop 63 or in the evaporator 43. The refrigerant, after having passed through the expansion valve 9, is partly vaporized in the evaporator 42a by lowering the temperature of the heat-transfer fluid of the circulation loop passing through the battery temperature conditioning heat exchanger 11f. The refrigerant then continues to vaporize by lowering the temperature of the air of the passenger compartment 33 drawn by the fan 25 through the evaporator 40, thus lowering the temperature of the air of the passenger compartment, returns to the compressor 8. The compressor 8 returns the refrigerant at a higher pressure to the condenser 42b, where the refrigerant liquefies by releasing the heat that it has stored in the “pre-cooled” heat-transfer fluid passing through the storage tank 50. The electric engine is therefore cooled independently of the operation of the climate control circuit 4, and the air of the passenger compartment and the battery are cooled by means of the climate control circuit 4 whose efficiency is improved by virtue of the refrigeration stored in the heat-transfer fluid passing through the tank 50 and the condenser 42b.

This configuration can in particular be advantageous when the temperature of the heat-transfer fluid present in the tank 50 is higher than the desired temperature of the air in the passenger compartment, but nevertheless lower than the temperature of the heat-transfer fluid passing through the radiator 13.

The invention is not limited to the exemplary embodiments described, and may be the object of numerous variants. Other elements of the vehicle, in particular other electric units, may have heat exchangers or temperature conditioning condensers-evaporators. The invention can be applied to a vehicle with exclusively electric propulsion, to a hybrid vehicle, or even to a vehicle having an internal combustion engine, in order to reduce the overall energy consumption and therefore the fuel consumption of this vehicle. Numerous other operating modes can be applied, including for the systems described in FIGS. 1 to 21. For example, before starting the vehicle on a warm day, the battery recharging step may be accompanied by a starting-up of a climate control circuit in air conditioning mode, in order to cool the heat-transfer fluid circulating through a battery temperature conditioning heat exchanger. An overheating of the battery during the recharging phase is thus avoided, as is the consumption of additional energy, whether for storing heat and refrigeration in a larger volume of heat-transfer fluid, or for conditioning the temperature of the air of the passenger compartment.

It is possible to envisage adding other complementary PTCs at other points of the heat-transfer fluid circuit and it is also possible to envisage adding PTCs for directly heating the air of the passenger compartment. The temperature conditioning of the air of the passenger compartment can also be obtained solely by means of an evaporator and a condenser of the climate control circuit, without passing the heat-transfer fluid circuit through the passenger compartment. The “cold” heat-transfer fluid loops (i.e., colder than the air outside the vehicle) may then be dedicated solely to the electric units and to the battery of the vehicle.

It is possible to envisage regulating the heating of the air of the passenger compartment by means of a condenser of the climate control circuit associated with a PTC resistor on the air of the passenger compartment, and regulating the cooling of the air of the passenger compartment through an exchanger of the heat-transfer fluid circuit.

It is possible to envisage regulating the cooling of the air of the passenger compartment by means of an evaporator of the climate control circuit, and regulating the heating of the air of the passenger compartment through an exchanger of the heat-transfer fluid circuit, possibly coupled to a PTC resistor, arranged on the heat-transfer circuit or directly reheating the air of the passenger compartment.

It is possible to provide a circulation of heat-transfer fluid directly linking a heat exchanger with the engine of the vehicle, and linking a heat exchanger with the air of the passenger compartment.

It is possible to envisage variants of the invention comprising a simple, non-reversible, refrigerating loop, but with possibilities for modulating the circulations of heat-transfer fluid, making it possible to alternatively connect the cold source and the hot source of the refrigerating loop, one, with a heat-transfer fluid loop passing through the passenger compartment, the other, with a heat-transfer fluid loop used as heat storage loop.

The heat-transfer fluid may be more generally replaced by a heat regulation fluid capable of changing phase.

The heat regulation system according to the invention makes it possible to manage the temperatures both of the passenger compartment and of the engine compartment, by optimizing the potentials for recovery, between the passenger compartment and the engine, of heat or refrigeration by the heat pump, and by maximizing the efficiency of the heat pump. The system also makes it possible to store, in the form of specific heat, before the vehicle is started, a certain quantity of heat or refrigeration which will not, because of this, be taken from the energy of the battery. The total energy consumption and the range of the vehicle are thus both enhanced.

1-12. (canceled)

13. A heat regulation system for a passenger compartment and electric units of a motor vehicle propelled totally or partially by an electric engine powered by a battery, the system comprising:
a heat regulation fluid circuit coupled to a heating means and/or to a cooling means making it capable of storing heat or refrigeration when the system is connected to an electricity network outside the vehicle,
the fluid circuit configured to release heat and/or refrigeration into air of the passenger compartment of the vehicle, in an alternating manner, either through a heat exchanger between the circuit and the air of the passenger compartment, or via a climate control circuit forming a heat pump and/or an air conditioning system.

14. The heat regulation system as claimed in claim 13, further comprising:
a first independent heat regulation fluid circuit for the passenger compartment, fed by a first pump and passing through a first heat exchanger for conditioning temperature of a flow of air entering into the passenger compartment, or for conditioning temperature of the battery;
a second independent heat regulation fluid circuit for the engine, fed by a second pump, passing through a radiator exchanging heat with air outside the vehicle, and passing through a second heat exchanger conditioning the temperature of the engine;
a third heat storage fluid circuit, which can be alternatively connected to the first circuit and/or be connected to the engine temperature conditioning heat exchanger, and which can at other times form a separate independent fluid circulation loop;
a climate control circuit forming a heat pump and/or air conditioning system, capable of taking, via a first condenser-evaporator, heat or refrigeration from the third fluid circuit, and of releasing this heat/refrigeration, via a second condenser-evaporator, to the first fluid circuit;
at least one electric heating element linked either to the first fluid circuit, or to the third fluid circuit, and used to raise by tens of degrees Celsius the temperature of the third circuit, or the temperature of the two circuits connected together.

15. The heat regulation system as claimed in claim 14, comprising at least three three-way valves or three equivalent devices, used to stop exchanges of fluid between the first circuit and the third circuit, and at a same time used to alternatively obtain the following configurations:
either establishing a circulation of fluid between the engine temperature conditioning heat exchanger, the first condenser-evaporator, and the third fluid circuit;
or establishing a circulation of fluid between the heat exchange radiator exchanging heat with the air outside the vehicle and the first condenser-evaporator, the circulation of fluid of these two elements then being isolated from the third fluid circuit;
or establishing a circulation of fluid between the heat exchange radiator exchanging heat with the air outside the vehicle, the engine temperature conditioning heat exchanger and the first condenser-evaporator, the circulation of fluid of these three elements then being isolated from the third fluid circuit.

16. The heat regulation system as claimed in claim 15, in which the three-way valves are also used to interrupt or reestablish the circulation of fluid between the second circuit and the third circuit.

17. The heat regulation system as claimed in claim 14, the third circuit further comprising a valve and a bypass line used to exclude the first condenser-evaporator from this circuit.

18. The heat regulation system as claimed in claim 17, the third circuit further comprising a plurality of valves and a plurality of bypass lines used to exclude, selectively, one or more condensers-evaporators from this circuit.

19. The heat regulation system as claimed in claim 13, further comprising an outside air temperature sensor, comprising a heat sensor arranged on the first fluid circuit or in the passenger compartment of the vehicle, comprising a heat sensor arranged on the second fluid circuit or on the engine temperature conditioning heat exchanger, and comprising a heat sensor arranged on the third fluid circuit.

20. The heat regulation system as claimed in claim 13, in which a volume of the fluid contained in the third circuit is greater than a volume of fluid contained in the first circuit and a volume of fluid contained in the second circuit.

21. The heat regulation system as claimed in claim 13, in which the third fluid circuit further comprises a heat exchanger with a heat accumulation means or a phase transformation heat accumulator.

22. A heat regulation method for a passenger compartment and electric units of a motor vehicle propelled totally or partially by an electric engine powered by a battery, by a device comprising a circuit of lines for heat regulation fluid, coupled to a heating means and/or to a cooling means, the method comprising:
storing heat or refrigeration in the fluid circuit when the vehicle is connected to an electricity network outside the vehicle, to recharge its battery;
then supplying heat or refrigeration to the air of the passenger compartment from the fluid circuit:
initially through a heat exchanger between the circuit and air of the passenger compartment,
then via a climate control circuit forming a heat pump and/or air conditioning system.

23. A heat regulation method for a passenger compartment and electric units of a motor vehicle propelled totally or partially by an electric engine powered by a battery, the vehicle comprising:
a first independent heat regulation fluid circuit for the passenger compartment, fed by a first pump and passing through a first heat exchanger for conditioning temperature of a flow of air entering into the passenger compartment, or for conditioning temperature of the battery;
a second independent heat regulation fluid circuit for the engine, fed by a second pump, passing through a heat exchange radiator exchanging heat with the air outside the vehicle, and passing through a second engine temperature conditioning heat exchanger;
a third heat storage fluid circuit, which can be alternatively connected to the first circuit and/or be connected to the engine temperature conditioning heat exchanger, and which can at other times form a separate independent fluid circulation loop;
a climate control circuit forming a heat pump and/or air conditioning system, capable of taking, via a first condenser-evaporator, heat/refrigeration from the third fluid circuit, and of releasing this heat/refrigeration via a second condenser-evaporator to the first fluid circuit,
the method comprising:
before the vehicle is started, using energy of an electricity network outside the vehicle to accumulate, using the heating element or using the climate control circuit, heat or refrigeration in the third heat storage fluid circuit, possibly linked to the first circuit, by raising by lowering temperature of this circuit relative to temperature of air outside the vehicle;
after the vehicle is started, the climate control circuit is deactivated, the third circuit is linked to the first circuit and/or to the engine temperature conditioning heat exchanger, and the heat or the refrigeration stored in the third fluid circuit are used to condition the temperature of the passenger compartment plus, possibly, the engine and/or the battery;
when the temperature of the fluid of the third circuit crosses a minimum deviation representing the difference with the temperature of the air of the passenger compartment, the fluid circulation between the first circuit and the third circuit is decoupled, and the heat pump or the air conditioning system is made to operate, first between the first circuit or the passenger compartment and the third circuit, then between the first circuit or the passenger compartment and at least a part of the second circuit, the fluid circulation of the lines specific to the third circuit then being deactivated.

24. The heat regulation method as claimed in claim 23, in which the temperature of the outside air, a temperature on the heat exchanger of the engine, a temperature in the passenger compartment of the vehicle, and a temperature of the third fluid circuit are compared with one another, to decide on how the first, second, and third fluid circuits should be connected, and to decide on a mode of operation or absence of operation of the climate control circuit.
